(19) United States
(12) Patent Application Publication
(10) Pub. No.: US 2025/0117885 A1
(43) Pub. Date: Apr. 10, 2025

(54) BYGENERATION OF HYBRID IMAGES FOR USE IN CAPTURING PERSONALIZED PLAYBACK-SIDE CONTEXT INFORMATION OF A USER

(71) Applicant: DOLBY LABORATORIES LICENSING CORPORATION

(72) Inventors: Doh-Suk KIM, Cupertino, CA (US); Jeffrey RIEDMILLER, Novato, CA (US); Sean Thomas MCCARTHY, San Francisco, CA (US); Scott DALY, Kalama, WA (US)

(73) Assignee: DOLBY LABORATORIES LICENSING CORPORATION, (US)

(21) Appl. No.: 18/836,221

(22) PCT Filed: Feb. 3, 2023
(86) PCT No.: PCT/US2023/061997

§ 371 Date: Aug. 6, 2024

Related U.S. Application Data
(60) Provisional application No. 63/307,566, filed on Feb. 7, 2022.

(30) Foreign Application Priority Data
Mar. 7, 2022 (EP) 22160457.2

(51) Int. Cl. G06T 5/20; G06T 5/50

(52) U.S. Cl. CPC G06T 5/20; G06T 5/50

(57) ABSTRACT

A method may include generating a hybrid image associated with a first interpretation corresponding to a first value of a media parameter and a second interpretation corresponding to a second value of the media parameter. The hybrid image may include a first visibility ratio between the first interpretation and the second interpretation. The method may include refining the hybrid image to create a refined hybrid image that includes a second visibility ratio different than the first visibility ratio. The method may include displaying the refined hybrid image, and receiving a user input related to a first perception of the refined hybrid image by a user. The method may include determining, based at least in part on the user input, an optimized value of the media parameter, and providing output media for display to the user to a playback device according to the optimized value of the media parameter.

### CROSS-REFERENCE TO RELATED APPLICATIONS

This application claims priority to European Patent Application No. 22160457.2, filed Mar. 7, 2022, and U.S. provisional application 63/307,566, filed Feb. 7, 2022, all of which are incorporated herein by reference in their entirety.

### TECHNICAL FIELD

The present application relates to media. More specifically, embodiments of the present invention relate to processing, displaying, and/or delivering visual media.

### SUMMARY

Various aspects of the present disclosure relate to devices, systems, and methods to provide delivery of visual media over a network to user devices for display of the visual media by the user devices for viewing by a user. As described in PCT Application No. PCT/US2020/044241, filed Jul. 30, 2020, now International Publication No. WO 2021/025946, the entire contents of which are hereby incorporated by reference and appended herein as Appendix B, in the visual media delivery chain, adaptive bit rate (ABR) streaming allows for improved network resource management through adaptive selection of bit rate and resolution on a media ladder based on network conditions, playback buffer status, shared network capacity, and other factors influenced by the network. Besides ABR streaming, other media delivery methods (which also may include coding methods or source coding methods) may similarly be used to control one or more media parameters of an upstream video encoder/transcoder/transrater such as bit rate, frame rate, resolution, etc. For example, the methods described herein are also applicable to scalable video coding (e.g., H.264/scalable video coding (SVC), H.265/Scalable High efficiency video coding (SHVC), versatile video coding (VVC) Multilayer Main 10, VP9 video coding, and AOMedia Video 1 (AV1)), simulcast of multiple alternative bitstreams, and the reference picture resampling (RPR) coding tool in VVC for use cases including broadcast, broadband, one-to-one and multi-party video communication.

Also as described in PCT Application No. PCT/US2020/044241, it is advantageous to share parameters related to playback device characteristics and personalized visual-sensitivity factors with the upstream devices configured to control the transmission of visual media to the playback devices. Specifically, providing personalized and adaptive media delivery based on collected playback-side information often without using individual sensors is advantageous. Additionally, the collected playback-side information may be indicative of personalized quality of experience (QoE) for different users and/or different viewing environments. Accordingly, there may be improvements in network resource management/media delivery efficiency while maintaining personalized QoE for each user.

PCT Application No. PCT/US2020/044241 also describes the use of hybrid images to gather data that may be used to estimate a QoE of a user, for example, in response to user inputs relating to the user's perception of displayed hybrid images. However, not all hybrid images are useful to evaluate the user's perception of the hybrid images.

Accordingly, the disclosed devices, systems, and methods aim to address the above-noted technical problem to generate (or select or receive) hybrid images that are more useful to evaluate the user's perception of hybrid images with respect to relevant values of media parameters used to control delivery of visual media over a network to user devices. In other words, the disclosed devices, systems, and methods involve sensorless methods to capture playback-side context information using hybrid images for improved media processing and delivery. The disclosure includes methods to create hybrid images for estimating approximate minimum resolution for approximate maximum quality of experience (e.g., an approximate minmax QoE resolution) given a set of available video resolution settings of media streaming. The disclosure also includes methods to estimate a model (e.g., an estimated QoE transfer function, an estimated contrast sensitivity function (CSF), etc.) of playback-side context information as a function of spatial frequency. In some embodiments, the disclosed devices, systems, and methods are used in conjunction with context/environment sensors (e.g., sensors of a playback device configured to gather context information such as ambient light information, viewing distance between a user and the playback device, a time of day and/or a geographic location of the playback device, etc.) to capture playback-side context information using hybrid images for improved media processing and delivery.

In one embodiment of the present disclosure, there is provided a method that may be performed by one or more electronic processors. The method may include at least one of generating and selecting, with one or more electronic processors, a hybrid image associated with a first interpretation corresponding to a first value of a media parameter and a second interpretation corresponding to a second value of the media parameter. The hybrid image may include a first visibility ratio between the first interpretation and the second interpretation. The method may further include refining, with the one or more electronic processors, the hybrid image to create a refined hybrid image that includes a second visibility ratio different than the first visibility ratio. The method may further include displaying, on a display of a first playback device, the refined hybrid image. The method may further include receiving, with the one or more electronic processors, a first user input from a first user. The first user input may be related to a first perception of the refined hybrid image by the first user. The method may further include determining, with the one or more electronic processors and based at least in part on the first user input, an optimized value of the media parameter. The method may further include providing, over a network, first output media to the first playback device in accordance with the optimized value of the media parameter. The first output media may be configured to be output with the first playback device.

In another embodiment, there is provided a non-transitory computer-readable storage medium storing one or more programs configured to be executed by one or more electronic processors of an electronic computing device that may include a network interface and a display. The one or more programs may include instructions for performing the method described above and/or any of the methods described herein.

In another embodiment, there is provided an electronic computing device that may include a network interface, a display, one or more electronic processors, and a memory storing one or more programs configured to be executed by the one or more electronic processors. The one or more programs may include instructions for performing the method described above and/or any of the methods described herein.

Other aspects of the embodiments will become apparent by consideration of the detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

FIG. 1 illustrates an example media coding and delivery system according to embodiments described herein.

FIG. 2 illustrates a block diagram of a playback device of the media coding and delivery system of FIG. 1 according to embodiments described herein.

FIG. 3 illustrates a block diagram of a media server of the media coding and delivery system of FIG. 1 according to embodiments described herein.

FIGS. 4A and 4B illustrate example source images that may be used to generate example hybrid images shown in FIGS. 4C-4E according to embodiments described herein.

FIGS. 4C-4E illustrate example hybrid images that are generated using the example source images shown FIGS. 4A and 4B according to embodiments described herein.

FIG. 5 illustrates examples of an azimuthally averaged 1-d power spectra along radii from an origin for the source images shown in FIGS. 4A and 4B according to embodiments described herein.

FIGS. 6A. 7A, 8A, and 9A illustrate example filter responses of 6th order Butterworth low pass and high pass filters that are respectively used to filter the source images of FIGS. 4A and 4B according to embodiments described herein.

FIGS. 6B. 7B, 8B, and 9B illustrate low pass-filtered images of the source image of FIG. 4A according to embodiments described herein.

FIGS. 6C, 7C, 8C, and 9C illustrate high pass-filtered images of the source image of FIG. 4B according to embodiments described herein.

FIGS. 6D, 7D, 8D, and 9D illustrate hybrid images created by adding the filtered source images of FIGS. 6B, 7B, 8B, and 9B to the respective filtered source images of FIGS. 6C, 7C, 8C, and 9C according to embodiments described herein.

FIGS. 6E, 7E, 8E, and 9E respectively illustrate examples of an azimuthally averaged 1-d power spectra along radii from an origin for the low pass-filtered source image of FIGS. 6B, 7B, 8B, and 9B and the high pass-filtered source image of FIGS. 6C, 7C, 8C according to embodiments described herein.

FIGS. 6F, 7F, 8F, and 9F respectively illustrate modified versions of the graphs of FIGS. 6E, 7E, 8E, and 9E where the low pass-filtered image of FIG. 6B and the high pass-filtered image of FIG. 6C are equalized in energy according to embodiments described herein.

FIGS. 6G, 7G, 8G, and 9G respectively illustrate modified versions of the hybrid images shown in FIGS. 6D, 7D, 8D, and 9D where the low pass-filtered image of FIG. 6B and the high pass-filtered image of FIG. 6C are equalized in energy according to embodiments described herein.

FIG. 10 illustrates multiple graphs of spectral distribution of a hybrid image consisting of filtered images A and B with image size altered in each graph to demonstrate a relationship between image size and cutoff frequency according to embodiments described herein.

FIG. 11 illustrates a flow diagram of generating a refined hybrid image for displaying to a user 135 to evaluate vision capabilities of the user above a test frequency (fₜₑₛₜ) according to embodiments described herein.

FIGS. 12A, 13A, and 14A illustrate three different example refined hybrid images generated in accordance with the flow diagram of FIG. 11 according to embodiments described herein.

FIGS. 12B, 13B, and 14B respectively illustrate a low pass-filtered image spectra and a high pass-filtered image spectra of the low pass-filtered image and the high pass-filtered image that are combined to make the respective refined hybrid images shown in FIGS. 12A, 13A, and 14A according to embodiments described herein.

FIGS. 15 and 16 each illustrate five refined hybrid images with increasing gain values for a high pass-filtered image from left to right according to embodiments described herein.

FIG. 17 illustrates a flowchart of a method that may be performed by an electronic computing device to generate hybrid images for use in capturing personalized playback-side context information of a user in an environment and providing output media to a playback device in accordance with the personalized playback-side context information according to embodiments described herein.

FIGS. 18A, 19A, and 20A illustrate the same three example refined hybrid images that are shown in FIGS. 12A, 13A, and 14A.

FIGS. 18B, 19B, and 20B illustrate graphs including a presumed contrast sensitivity function (CSF) of a user, a first CSF-weighted power spectra for a low pass-filtered first image. and a second CSF-weighted power spectra for a high pass-filtered second image according to embodiments described herein. The graphs of FIGS. 18B, 19B, and 20B also include the contents of the graphs of FIGS. 12B, 13B, and 14B.

FIG. 21 illustrates a graph of a difference (AP) between the power spectra for the low pass-filtered first images of FIGS. 18A, 19A, and 20A and the respective power spectra for the high pass-filtered second images of FIGS. 18A, 19A, and 20A (y-axis) at a gain of the high pass-filtered second image where a perception of the refined hybrid images of FIGS. 18A, 19A, and 20A by the user changed from the high pass-filtered second image to the low pass-filtered first image. The graph of FIG. 21 illustrates an unweighted AP curve and a CSF-weighted AP curve both as a function of a second scale factor (x-axis) for different refined hybrid image sizes.

### DETAILED DESCRIPTION

FIG. 1 illustrates an example media coding and delivery system 100. The system 100 includes a media server 105 that provides media (e.g., visual media) to a playback device 110 (e.g., playback system 110) over a network 115. Although FIG. 1 shows a single playback device 110, the media server 105 may be configured to provide (e.g., stream) the same or different media to additional playback devices 110. In some embodiments, the system 100 includes additional media servers 105, environments 130, and/or users 135. For example, the system 100 may be a decentralized coded multi-source, multi-path media delivery system that includes multiple media servers 105 and/or caches that store media content that may be provided to one or more playback devices 110 as described in PCT Application No. PCT/US21/63723, filed on Dec. 16, 2021, the entire contents of which are hereby incorporated by reference and appended herein as Appendix A.

The playback device 110 may include one or more playback devices of one or more types such as a television, a tablet, a smart phone, a computer, and the like. In some embodiments, the playback device 110 includes a buffer/decoder and a playback renderer as described in PCT/US2020/044241, filed Jul. 30, 2020, now International Publication No. WO 2021/025946, the entire contents of which are hereby incorporated by reference. The playback device 110 is located in an environment 130. A user 135 is also located in the environment 130 and may view media that is output by the playback device 110.

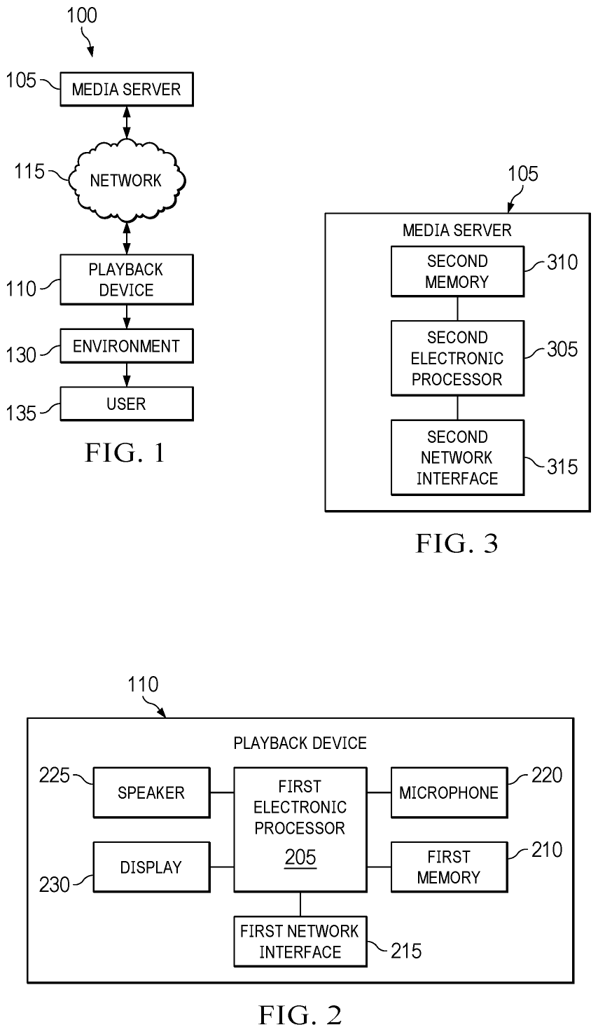

FIG. 2 is a block diagram of the playback device 110 (e.g., playback system 110) according to one example embodiment. As illustrated, the playback device 110 includes a first electronic processor 205 (for example, a microprocessor or other electronic device). The first electronic processor 205 includes input and output interfaces (not shown) and is electrically coupled to a first memory 210, a first network interface 215, an optional microphone 220, a speaker 225, and a display 230. In some embodiments, the playback device 110 includes fewer or additional components in configurations different from that illustrated in FIG. 2. For example, the playback device 110 may not include the microphone 220. As another example, the playback device 110 may include one or more additional input devices such as a computer mouse and/or a keyboard that receive inputs from the user 135 of the playback device 110. As yet another example, the playback device 110 may include environment sensors such as an ambient light sensor and/or a location tracking device (e.g., a global positioning system (GPS) receiver). In some embodiments, the playback device 110 performs functionality other than the functionality described below.

The first memory 210 may include read only memory (ROM), random access memory (RAM), other non-transitory computer-readable media, or a combination thereof. The first electronic processor 205 is configured to receive instructions and data from the first memory 210 and execute, among other things, the instructions. In particular, the first electronic processor 205 executes instructions stored in the first memory 210 to perform the methods described herein.

The first network interface 215 sends and receives data to and from the media server 105 over the network 115. In some embodiments, the first network interface 215 includes one or more transceivers for wirelessly communicating with the media server 105 and/or the network 115. Alternatively or in addition, the first network interface 215 may include a connector or port for receiving a wired connection to the media server 105 and/or the network 115, such as an Ethernet cable. The first electronic processor 205 may receive one or more data streams (for example, a video stream, an audio stream, an image stream, and the like) over the network 115 through the first network interface 215. The first electronic processor 205 may output the one or more data streams received from the media server 105 through the first network interface 215 through the speaker 225, the display 230, or a combination thereof. Additionally, the first electronic processor 205 may communicate data generated by the playback system 110 back to the media server 105 over the network 115 through the first network interface 215. For example, the first electronic processor 205 may transmit requests for media from the media server 105 based on a determination by the first electronic processor 205 of desired media parameters based on user inputs received in response to the display of hybrid images on the display 230. The media server 105 may then transmit one or more media streams to the playback device 110 in accordance with a request/determination from the playback device 110. As another example, the first electronic processor 205 may transmit data indicative of user inputs received in response to the display of hybrid images on the display 230 for analysis by the media server 105. The media server 105 may, itself, make a determination of desired media parameters for the playback device 110 and the user 135 based on the user inputs received in response to the display of hybrid images on the display 230. The media server 105 may then transmit one or more media streams to the playback device 110 in accordance with its determination of desired media parameters for the playback device 110 and the user 135 from the playback device 110.

The display 230 is configured to display images, video, text, and/or data to the user 135. The display 230 may be a liquid crystal display (LCD) screen or an organic light emitting display (OLED) display screen. In some embodiments, a touch sensitive input interface may be incorporated into the display 230 as well, allowing the user 135 to interact with content provided on the display 230. In some embodiments, the display 230 includes a projector or future-developed display technologies. In some embodiments, the speaker 225 and the display 230 are referred to as output devices that present media streams and other information to a user 135 of the playback device 110. In some embodiments, the microphone 220, a computer mouse, and/or a keyboard or a touch-sensitive display are referred to as input devices that receive input from a user 135 of the playback device 110. In some embodiments, an input device of the playback device 110 may also include a sensor or device configured to detect motion-based input (e.g., movement by the user 135). For example, such a sensor or device configured to detect motion-based input may include a virtual reality (VR)/augmented reality (AR) controller, a hand-held remote/wand configured to detect motion caused by the user 135, headphones with head-tracking of movement of the user's head, gaze detection sensors configured to determine where the eyes of the user 135 are looking and/or focused, and/or the like.

FIG. 3 is a block diagram of the media server 105 according to one example embodiment. In the example shown, the media server 105 includes a second electronic processor 305 electrically connected to a second memory 310 and a second network interface 315. These components are similar to the like-named components of the playback device 110 explained above with respect to FIG. 2 and function in a similar manner as described above. In some embodiments, the second network interface 315 sends and receives data to and from playback devices 110 via the network 115. In some embodiments, the media server 105 includes fewer or additional components in configurations different from that illustrated in FIG. 3. For example, the media server 105 may additionally include a display such as a touch screen to allow a backend user to reprogram settings or rules of the media server 105. In some embodiments, the media server 105 performs functionality other than the functionality described below.

While FIGS. 2 and 3 show separate block diagrams of the playback device 110 and the media server 105, in some embodiments, the media server 105, one or more playback devices 110, a remote cloud-computing cluster that communicates over or forms a part of the network 115, or a combination thereof is referred to an electronic computing device that performs the functionality described herein. For example, the electronic computing device may include a single electronic processor (for example, the second electronic processor 305 of the media server 105 or the first electronic processor 205 of the playback device 110) or a plurality of electronic processors located in the media server 105. In other embodiments, the electronic computing device includes multiple electronic processors distributed across different devices. For example, the electronic computing device may be implemented on one or more of the first electronic processor 205 of the playback device 110, the second electronic processor 305 of the media server 105, and one or more electronic processors located in one or more other devices located at a remote location or at a remote cloud-computing cluster that communicates over or forms a part of the network 115. In some embodiments, the remote cloud-computing cluster includes a Software-Defined-Network (SDN)/Network Function Virtualization (NFV)-enabled access-network.

Herein, the methods/actions are primarily described as being performed by the playback device 110 (in particular, the first electronic processor 205). However, it should be understood that, in some embodiments, one or more of the methods/actions described herein may additionally or alternatively performed by other devices (e.g., any single device or combination of devices that may make up the electronic computing device described above).

As described in PCT/US2020/044241, a hybrid image is a static image generated from at least two distinct source images. Hybrid images tend to have distinct interpretations depending on the user's viewing capabilities and environmental factors. As an example, human viewers lose their capability to see fine details of images as the viewing distance is increased, resulting in failing to distinguish between high- and low-resolution videos. In some embodiments, a hybrid image is a static image that produces two or more distinct interpretations (e.g., a first interpretation dominated by/based on a first source image and a second interpretation dominated by/based on a second source image) to a human user that change as a function of spatial frequency range and/or viewing distance. Based on user responses to hybrid images displayed by the playback device 110, the playback device 110 may estimate dominant and non-dominant spatial frequency ranges of the user 135 in the media viewing environment 130 without using an explicit sensor.

Also as described in PCT/US2020/044241, to create a hybrid image, two different source images may be processed differently to make a certain spatial frequency range dominant with respect to each processed image included in the hybrid image. For example, a first source image may be low-pass filtered and a second source image may be high-pass filtered. The low-pass filtered source image may then be combined with (e.g., overlayed on top of) the high-pass filtered source image to create a hybrid image. Because the sensitive region of a given image in spatial frequency moves from lower frequencies to higher frequencies as the viewing distance of the user 135 is decreased, a human user more easily perceives the high-pass filtered source image at shorter viewing distances than at longer viewing distances. Conversely, a human user more easily perceives the low-pass filtered source image at longer viewing distances than at shorter viewing distances. In other words, either the low-pass filtered source image or the high-pass filtered source image may be perceived by the user 135 as dominant depending on one or more viewing characteristics of the user 135 and/or of the environment 130 of the user 135.

Throughout this disclosure, reference is made to the generation of one or more hybrid images. In some embodiments, one or more of the hybrid images are generated by the electronic computing device by overlaying source images as described herein. In some embodiments, electronic computing device may select and/or receive previously-generated and stored hybrid images with characteristics corresponding to the values of desired viewing/testing parameters as described herein. For example, the playback device 110 may select, retrieve, and/or receive stored hybrid images from the media server 105 and/or from another device external to the playback device 110.

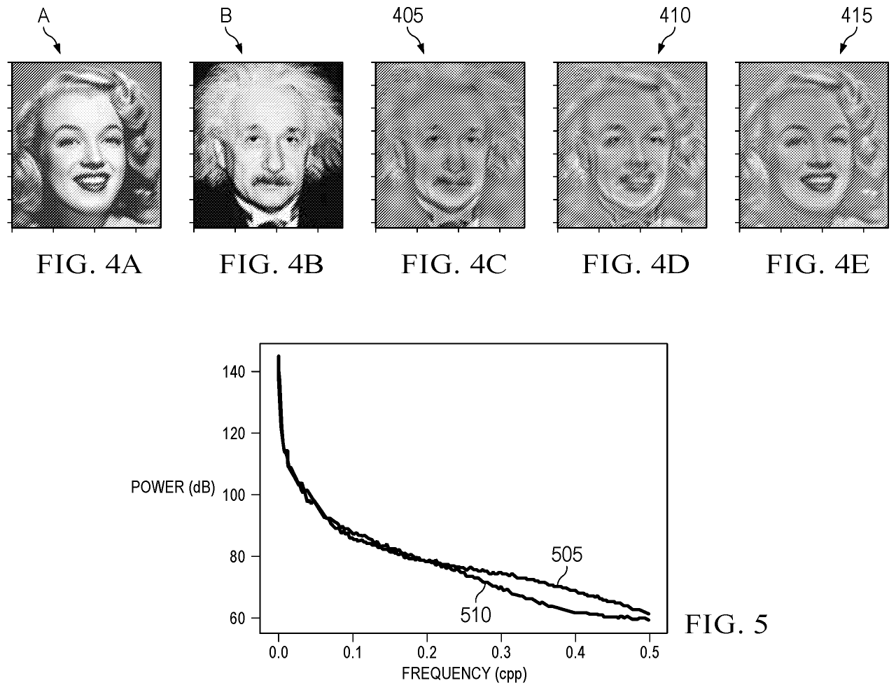

FIGS. 4A and 4B illustrate example source images that are used to generate example hybrid images shown in FIGS. 4C-4E. In the examples shown, FIG. 4A is a source image A of a woman and FIG. 4B is a source image B of a man. Each of the three hybrid images 405, 410, 415 of FIGS. 4C-4E may be generated by adding a low pass-filtered source image A (e.g., the female image) and a high pass-filtered source image B (e.g., the male image) with different cutoff frequencies used for the filtering in each hybrid image 405, 410, 415. For example, the cutoff frequency used by a low pass filter and a high pass filter to generate the hybrid image 405 of FIG. 4C is lower than the cutoff frequency used by the low pass filter and the high pass filter to generate the hybrid images 410 and 415 of FIGS. 4D and 4E. The cutoff frequency used by the low pass filter and the high pass filter to generate the hybrid image 410 of FIG. 4D is between the cutoff frequencies used by the low pass filter and the high pass filter to generate the hybrid images 405 and 415 of FIGS. 4C and 4E. The cutoff frequency used by the low pass filter and the high pass filter to generate the hybrid image 415 of FIG. 4E is higher than the cutoff frequency used by the low pass filter and the high pass filter to generate the hybrid images 405 and 410 of FIGS. 4C and 4D. Accordingly, as illustrated in FIGS. 4C-4E, a percept (e.g., a dominant interpretation) of the hybrid images 405, 410, 415 transitions from male to female as the cutoff frequency is increased (and/or as a viewing distance of the user 135 is increased for a given hybrid image).

A technical problem with generating hybrid images is that generating useful hybrid images from two source images may not be able to be accomplished by merely combining any two source images. Rather, a number of factors of the source images may be considered when generating hybrid images to ensure that each of the two percepts/interpretations associated with the hybrid image are viewable in at least some viewing situations. For example, perceptual grouping modulates the effectiveness of hybrid image because visual systems group ambiguous blobs of low spatial frequencies to form a meaningful interpretation. According to the Gestalt rules of perception, the human eye may perceive a set of individual elements as a whole element. Thus, in a hybrid image, a non-dominant image interpretation should be perceived as noise to a dominant image rather than forming an independent image percept. As another example, one way to reduce the influence of one spatial channel of one source image over the other spatial channel of the other source image is to generate the hybrid image to have alignment of edges and blobs included in the two source images. As yet another example, the low pass filter and the high pass filter used to filter the source images should not have significant overlap in order to avoid ambiguous interpretations between the two source images.

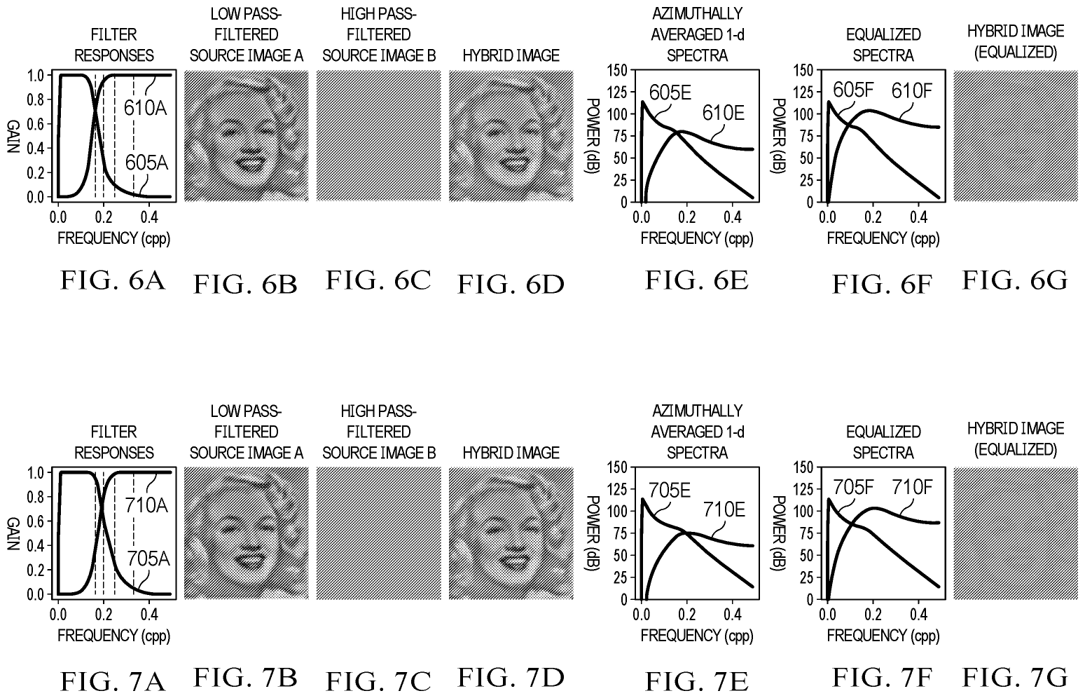

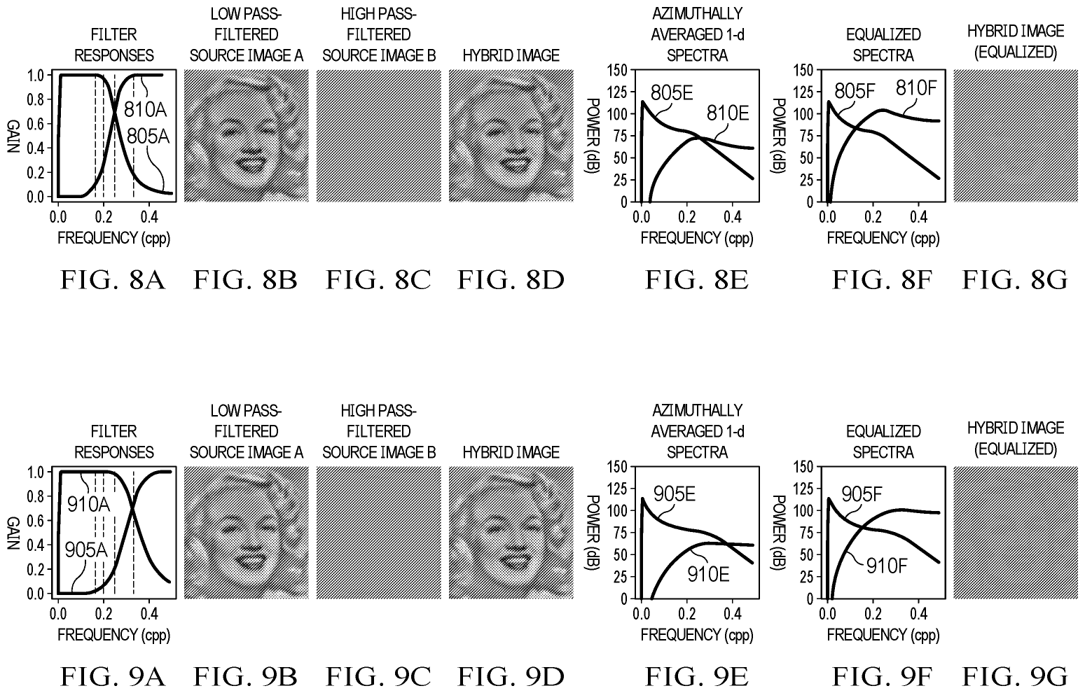

Additionally, another technical problem is that generating hybrid images that are useful to evaluate a user's perception of the hybrid images with respect to relevant values of media parameters used to control delivery of visual media over the network 115 to playback devices 110 by merely selecting the cutoff frequency of low pass and high pass filters used to filter source images to be approximately equivalent to, for example, Nyquist frequencies of an available video resolution of a media streaming application (e.g., 360p, 540p, 720p, and 1080p on a 1080p display) may not be possible in all viewing contexts. For example, as demonstrated in FIGS. 6-9, such hybrid images may be heavily dominated by a low pass-filtered image (e.g., low pass-filter source image A of a woman), unless a high pass-filtered image preserves a sufficient amount of information to form multiscale image perception. In other words, selecting any arbitrary cutoff frequencies when generating a hybrid image will not always produce useful hybrid images where human eyes are capable of perceiving each of the two interpretations in a hybrid image in at least some viewing situations due to the lowpass spectral characteristics of natural images.

FIG. 5 illustrates examples of the azimuthally averaged 1-d power spectra along radii from the origin for the source images A and B in FIGS. 4A and 4B. A curve 505 is representative of the source image A (female). A curve 510 is representative of the source image B (male). The y-axis represents power in decibels (dB), and the x-axis represents frequency in cycles per pixel (cpp). FIG. 5 illustrates the above-noted technical problem of generating hybrid images from natural images as FIG. 5 shows that the natural images of FIGS. 4A and 4B are dominated by their low frequency range spectra.

FIGS. 6-9 illustrate example images and graphs associated with hybrid images that are generated using cutoff frequencies that are equivalent to video resolutions of a presumed video streaming application (e.g., 0.17, 0.2, 0.25, and 0.33 cycles per pixel (cpp) that respectively correspond to the Nyquist frequencies of 360p, 432p, 540p, and 720p video on a 1080p display according to Equation 2 below). FIGS. 6A, 7A, 8A, and 9A illustrate example filter responses of 6th order Butterworth low pass (605A, 705A, 805A, 905A) and high pass filters (610A, 710A, 810A, 910A) that are respectively used to filter the source image A of FIG. 4A and the source image B of FIG. 4B based on the above-noted cutoff frequencies.

FIGS. 6B, 7B, 8B, and 9B illustrate low pass-filtered images of the source image A of FIG. 4A. FIGS. 6C, 7C, 8C, and 9C illustrate high pass-filtered images of the source image B of FIG. 4B. FIGS. 6D, 7D, 8D, and 9D illustrate hybrid images created by adding the filtered source images A of FIGS. 6B, 7B, 8B, and 9B to the respective filtered source images B of FIGS. 6C, 7C, 8C, and 9C. As shown in FIGS. 6D, 7D, 8D, and 9D, unlike in FIGS. 4C-4E, all of the hybrid images of FIGS. 6D, 7D, 8D, and 9D appear to be perceived as the low pass-filtered source image A (female) because the cutoff frequencies of high pass filters have removed important components for the image percept of the source image B (male). FIGS. 6C, 7C, 8C, and 9C further emphasize this removal of components from the source image B as the high pass-filtered source image B is not visible or is hardly visible in FIGS. 6C, 7C, 8C, and 9C.

FIGS. 6E, 7E, 8E, and 9E respectively illustrate examples of the azimuthally averaged 1-d power spectra along radii from the origin for the low pass-filtered source image A (605E, 705E, 805E, 905E) of FIGS. 6B, 7B, 8B, and 9B and the high pass-filtered source image B (610E, 710E, 810E, 910E) of FIGS. 6C, 7C, 8C, and 9C. FIGS. 6E, 7E, 8E, and 9E reveal the extent of spectral energy imbalance between the low pass-filtered source image A and the high pass-filtered source image B through the 1-d power spectra. Even when the low pass-filtered source image A and the high pass-filtered source image B are equalized in energy, as shown in FIGS. 6F, 7F, 8F, and 9F, the resulting hybrid images of FIGS. 6G, 7G, 8G, and 9G do not create satisfactory multiscale image perceptions/interpretations. In other words, as indicated by the graphs of FIGS. 6E, 7E, 8E, and 9E, the power of the two filtered source images of FIGS. 6-9 vary greatly with respect to each other depending on spatial frequency even when the low pass-filtered image and high pass-filtered image are equalized in energy as respectively shown by curves 605F, 705F, 805F. 905F and curves 610F, 710F, 810F, 910F in FIGS. 6F, 7F, 8F, and 9F. This large variance of power of the source images depending on spatial frequency with respect to each other causes the hybrid image to be less useful because, in many viewing situations, the high pass-filtered image is not perceptible to human eyes.

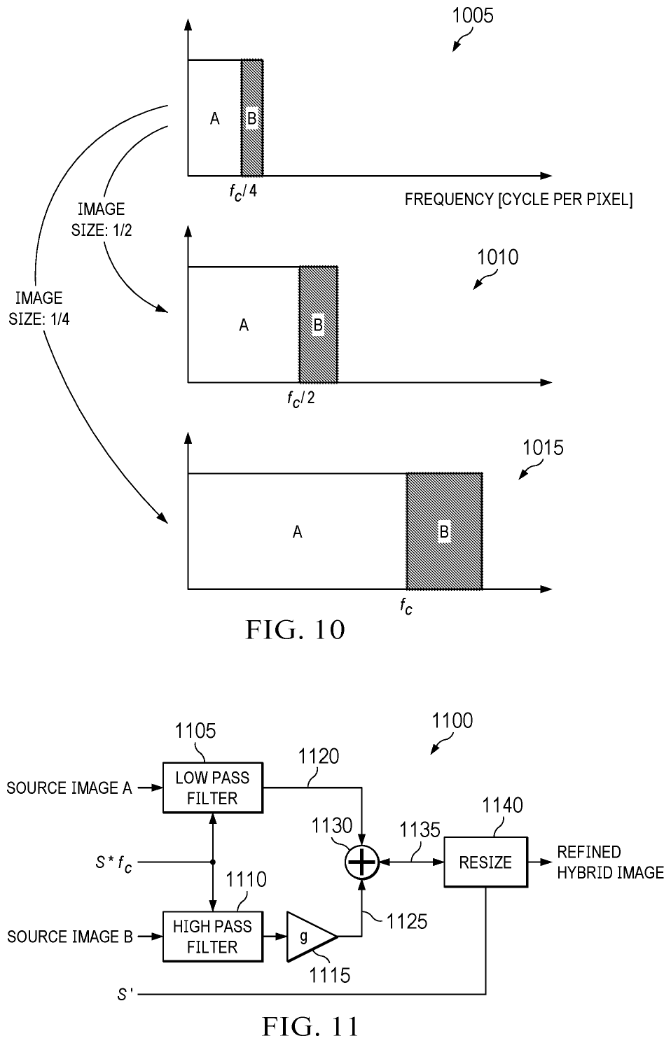

As illustrated in FIGS. 6-9, using the Nyquist frequencies corresponding to typical video resolutions in media streaming applications as cutoff frequencies for the filters of the source images A and B results in cutoff frequencies that are too high to preserve the percept/interpretation of the high pass-filtered source image B due to excessive loss of low frequency components (e.g., see FIGS. 6C, 7C, 8C, and 9C). To address this technical problem and to generate a hybrid image that is more useful to evaluate the user's perception of hybrid image with respect to relevant values of media parameters (e.g., the Nyquist frequencies corresponding to typical video resolutions in media streaming applications), the playback device 110 may take advantage of characteristics of frequency scaling of an image spectrum as shown in FIG. 10.

A top graph 1005 of FIG. 10 illustrates a spectral distribution of a hybrid image consisting of filtered images A and B with the cutoff frequency (f_{c}) at one fourth of a desired value (f_{c}/4) that may be one fourth of a Nyquist frequency value corresponding to a typical video resolution in a media streaming application. In some embodiments, one fourth of the desired cutoff frequency value is low enough to enable the percept/interpretation of the hybrid image dominated by the high pass-filtered image B with a proper gain adjustment. In other words, lowering a cutoff frequency to one fourth of a desired value may preserve the percept/interpretation of the high pass-filtered source image B such that the high pass-filtered source image B is visible to the user 135 under some viewing conditions. As indicated by the graphs 1010 and 1015 of FIG. 10, a frequency scale of the spectra is expanded as the image size is reduced. For example, when the hybrid image is displayed at one half of its original size (e.g., using half as many pixels along each of the length and width of the hybrid image), the frequency scale of the hybrid image is expanded from a fourth of the value of the desired cutoff frequency to half of the value of the desired cutoff frequency (f_{c}/2). Similarly, when the hybrid image is displayed at one fourth of its original size (e.g., using a fourth of the amount of pixels along each of the length and width of the hybrid image), the frequency scale of the hybrid image is expanded from a fourth of the value of the desired cutoff frequency to the value of the desired cutoff frequency (f_{c}).

Using the above-explained characteristics of frequency scaling of the image spectrum that are illustrated in FIG. 10, the playback device 110 may generate hybrid images where each of the source images A and B is perceptible to human eyes under some viewing conditions and where an effective cutoff frequency of the filtered source images A and B corresponds to relevant values of media parameters (e.g., the Nyquist frequencies corresponding to typical video resolutions in media streaming applications). In turn, based on user inputs in response to displayed hybrid images, the playback device 110 is able to evaluate visibility of frequency contents above an arbitrary test frequency (fₜₑₛₜ) that corresponds to relevant values of media parameters (e.g., the Nyquist frequencies corresponding to typical video resolutions in media streaming applications). In some embodiments, Equation 1 (below) may be used to set the arbitrary test frequency (fₜₑₛₜ).

$${f}_{test} = ( {f}_{c} S ) / {S}^{′} \qquad Equation 1$$

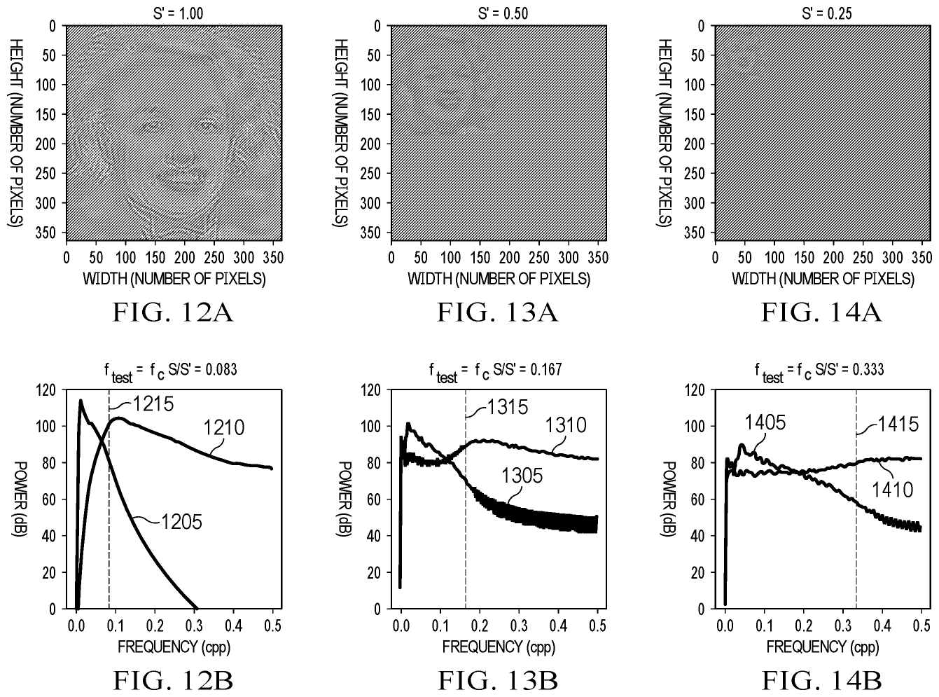

In some embodiments, fₜₑₛₜ represents a test frequency that the hybrid image is configured to test whether the user 135 can perceive frequency differences (e.g., changes in quality of experience (QoE)) above the test frequency. In some embodiments, the test frequency is equivalent to the initial cutoff frequency (f_{c}). For example, the test frequency is equivalent to the initial cutoff frequency when S=S′. In other words, in some embodiments, the first scaling factor and the second scaling factor may be the same (see FIGS. 14A-B) or may be different (see FIGS. 12A-B and 13A-B).

In some embodiments, f_{c} represents the initial cutoff frequency of the low pass filter used to filter the source image A and the initial cutoff frequency of the high pass filter used to filter the source image B. The initial cutoff frequency may correspond to a relevant value of a media parameter (e.g., the Nyquist frequencies corresponding to typical video resolutions in media streaming applications). For example, the initial cutoff frequency may be 0.17, 0.2, 0.25 or 0.33 cycle per pixel (cpp) that respectively correspond to the Nyquist frequencies of 360p, 432p. 540p, and 720p video on a 1080p display according to Equation 2 below.

$${f}_{cpp} = ( 0.5 * {f}_{Nyquist} ) / 1080. \qquad Equation 2$$

As explained previously herein, using the initial cutoff frequency that corresponds to a relevant value of a media parameter to generate a hybrid image may not result in a hybrid image that includes perceptions/interpretations of both the source images A and B that are visible to the human eyes. Accordingly, in some embodiments, a first scaling factor S (e.g., a first factor) is used to scale the initial cutoff frequency to a scaled cutoff frequency (f_{c}S). For example, the first factor S may be selected such that the percepts/interpretations of both filtered source images A and B are perceptible to human eyes in at least some viewing conditions. In some embodiments, the first factor S is less than one in order to reduce the initial cutoff frequency of the filters used to generate the hybrid image such that the cutoff frequency of the filters is low enough such that the percept/interpretation of the high pass-filter source image B is perceptible to human eyes in at least some viewing conditions. In some embodiments, the scaled cutoff frequency of the low pass filter and the high pass filter are the same. In some embodiments, the scaled cutoff frequency of the low pass filter and the high pass filter are different and may be separated by a separation value (df). In some embodiments, the frequency separation of the filters used to generate the hybrid image may be adjusted by making a first scaled cutoff frequency of the low pass filter f_{c}S−df and a second scaled frequency of the high pass filter f_{c}S+df.

In some embodiments, S′ represents a second scaling factor (e.g., second factor) used to scale a size of the hybrid image configured to be displayed on the display 230 of the playback device 110. In some embodiments, scaling the size of the hybrid image changes a number of pixels along each of the length and width of the hybrid image that is used by the display 230 to display the hybrid image. For example, a second scaling factor S′ of 0.50 may reduce the display of both the length and width of the hybrid image to be half as many pixels as the hybrid image otherwise would have been displayed (e.g., see the difference in size between FIGS. 12A and 13A).

Using Equation 1, the scaled cutoff frequency of the low pass and high pass filters used to respectively filter the source images A and B may be set low enough to control the interpretations shown in the hybrid image (particularly the interpretation of the high pass-filtered source image B). Additionally, by changing the values of the variables in Equation 1, the same hybrid image can be used to evaluate vision capabilities of the user 135 above an arbitrary test frequency simply be resizing the hybrid image by the second scaling factor S′ in accordance with a desired test frequency to be tested.

FIG. 11 illustrates a flow diagram 1100 of generating a refined hybrid image for displaying to the user 135 to evaluate vision capabilities of the user 135 above the test frequency (fₜₑₛₜ) calculated according to Equation 1. As explained previously herein, among other devices, the first electronic processor 205 of the playback device 110 may implement the functions shown in FIG. 11.

As shown in the example of FIG. 11, source image A of FIG. 4A (female) is low pass-filtered by a low pass filter 1105 using the scaled cutoff frequency (f_{c}S) to generate a low pass-filtered first image 1120. In other words, the first electronic processor 205 may be configured to scale, by a first factor(S), a first cutoff frequency of the low pass filter 1105 used to filter a first image to a first scaled cutoff frequency (f_{c}S). As explained previously herein, the first cutoff frequency (f_{c}) may be selected based on a first value and/or a second value of a media parameter (e.g., based on the Nyquist frequencies corresponding to typical video resolutions in media streaming applications) that respectively corresponds to interpretations associated with the hybrid image that can be perceived by human eyes in at least some viewing conditions.

Similarly, source image B of FIG. 4B is high pass-filtered by a high pass filter 1110 using the scaled cutoff frequency (f_{c}S) to generate a high pass-filtered second image 1125. In other words, the first electronic processor 205 may be configured to scale, by the first factor(S), a second cutoff frequency of a high pass filter 1110 used to filter a second image to a second scaled cutoff frequency (f_{c}S). As described previously herein, in some embodiments, the first cutoff frequency and the second cutoff frequency may be equivalent or may be different than each other. Similar to the first cutoff frequency, the second cutoff frequency (f_{c}) may be selected based on a first value and/or a second value of the media parameter that respectively correspond to interpretations associated with the hybrid image that can be perceived by human eyes in at least some viewing conditions.

In some embodiments, at block 1115, a gain (g) of high pass-filtered source image B is adjusted (e.g., increased) to control the desired percept/interpretation of the high pass-filtered source image B within the refined hybrid image. For example, the gain (g) may be increased to make the high pass-filtered source image B more visible to human eyes. Although not shown in FIG. 11, in some embodiments, a gain of the low pass-filtered source image A may additionally or alternatively be adjusted to control the desired percept/interpretation of the low pass-filtered source image A within the refined hybrid image.

In some embodiments, the value of the scaled cutoff frequency (f_{c}S) is determined by setting the cutoff frequency (f_{c}) to be the same as a Nyquist frequency of one of the available video resolution (e.g., 720p on a 1080p display, e.g., f_{c}=720/2*1080=0.333 cpp according to Equation 2) that is desired to be tested. In some embodiments, the first scaling factor(S) may be empirically determined such that the scaled cutoff frequency (f_{c}S) becomes low enough to enable controlling the percept/interpretation of the hybrid image between the source image A and source image B (e.g., controlling which source image A or B is predominantly visible to the human eyes in the hybrid image) through the adjustment of the gain (g) of high pass filter used to filter the source image B.

At block 1120, the low pass-filtered source image A (1120) and the high pass-filtered source image B (1125) are combined with each other (e.g., overlayed on top of each other) to generate a scaled cutoff frequency filtered hybrid image 1135. In some embodiments, the scaled cutoff frequency filtered hybrid image 1135 includes a first interpretation provided by the low pass-filtered first image 1120 that is visible to human eyes under at least some viewing conditions and a second interpretation provided by the high pass-filtered second image 1125 that is visible to human eyes under at least some viewing conditions.

At block 1140, a size of the scaled cutoff frequency filtered hybrid image 1135 configured to be displayed on the display 230 of the playback device 110 is scaled by the second scaling factor (S′) to a scaled size. Scaling the size of the scaled cutoff frequency filtered hybrid image 1135 resizes the scaled cutoff frequency filtered hybrid image to generate a refined hybrid image designed to test the vision capabilities of the user 135 at a desired test frequency (fₜₑₛₜ). As explained previously herein, in some embodiments, scaling the size of the scaled cutoff frequency filtered hybrid image 1135 scales a number of pixels along each of the length and width of the scaled cutoff frequency filtered hybrid image 1135 that is used by the display 230 to display the scaled cutoff frequency filtered hybrid image 1135.

FIGS. 12A, 13A, and 14A illustrate three different example refined hybrid images generated in accordance with the flow diagram 1100 of FIG. 11. Correspondingly, FIGS. 12B, 13B, and 14B illustrate a low pass-filtered image spectra 1205, 1305, 1405 and high pass-filtered image spectra 1210, 1310, 1410 of the low pass-filtered image and the high pass-filtered image that are combined to make the respective refined hybrid images shown in FIGS. 12A, 13A, and 14A. In each of FIGS. 12A, 13A, and 14A, the initial cutoff frequency (f_{c}) is set to 0.33 cycles per pixel (cpp) that corresponds to 720p video resolution on a 1080p display based on previously shown Equation 2: (0.5*720)/1080=0.333 cpp. The first scaling factor(S) is set to 0.25 in each of FIGS. 12A, 13A, and 14A. Accordingly, the scaled cutoff frequency (f_{c}S) in each of FIGS. 12A, 13A, and 14A is approximately 0.0833. In the examples shown in FIGS. 12A-14C, the energy of the two filtered images is equalized.

In each of FIGS. 12A, 13A, and 14A, a size of the refined hybrid image is scaled differently as indicated by the number of pixels along the length and width of each refined hybrid image. In other words, the second scaling factor (S′) is different in each of FIGS. 12A, 13A, and 14A. For example, the second scaling factor is 1.0 in FIG. 12A meaning that the size of the refined hybrid image is not adjusted after filtering and combination of the source images A and B. As another example, the second scaling factor is 0.50 in FIG. 13A meaning that the size of the refined hybrid image is reduced by 50% after filtering and combination of the source images A and B. As yet another example, the second scaling factor is 0.25 in FIG. 14A meaning that the size of the refined hybrid image is reduced by 25% after filtering and combination of the source images A and B. Using Equation 1, a test frequency (fₜₑₛₜ) for each of the refined hybrid images of FIGS. 12A, 13A, and 14A may be determined as indicated in FIGS. 12B, 13B, and 14B. For FIG. 12A, the test frequency is 0.083, which corresponds to 180p on a 1080p display according to Equation 2: (0.5*180)/1080=0.083 cpp. For FIG. 13A, the test frequency is 0.167, which corresponds to 360p on a 1080p display according to Equation 2: (0.5*360)/1080=0.167 cpp. For FIG. 14A, the test frequency is 0.333, which corresponds to 720p on a 1080p display according to Equation 2: (0.5*720)/1080=0.333 cpp. The test frequency for each hybrid image of FIGS. 12A, 13A, and 14A is respectively represented by a dashed vertical line 1215, 1315, 1415 in FIGS. 12B, 13B, and 14B.

Each of the different sized refined hybrid images of FIGS. 12A, 13A, and 14A may be used to evaluate the vision capabilities of the user 135 higher than the spatial frequency corresponding to its respective test frequency (fₜₑₛₜ). For example, the refined hybrid image of FIG. 14A may be used to evaluate the vision capabilities of the user 135 at higher than 0.333 cpp (corresponding to 720p video resolution on a 1080p display). In other words, the refined hybrid image of FIG. 14A may be used to determine whether the eyes of the user 135 are capable of distinguishing a difference between 720p video resolution and higher video resolution (e.g., 1080p video resolution). For a user 135 who can see thirty cycles per degree, sitting at 3H viewing distance (e.g., a viewing distance three times a height of the display) of a 1080p display, the visual resolution capability is approximately 1146 pixels in one picture height, and there should exist a gain that can make the refined hybrid image be perceived by such a user 135 as the interpretation corresponding to the high pass-filtered image B (male). In other words, if the user 135 can perceive the high pass-filtered image B (male) in the refined hybrid image shown in FIG. 14A, then the user 135 is capable of distinguishing between 720p video resolution and higher video resolutions. On the other hand, if the user 135 cannot perceive the high pass-filtered image B (male) in the refined hybrid image shown in FIG. 14A, then the user 135 is not capable of distinguishing between 720p video resolution and higher video resolutions. In the latter situation, presenting media to the user 135 that is higher than 720p video resolution (e.g., 1080p video resolution) does not result in increased quality of experience (QoE) because the user 135 cannot perceive the difference between 720p video resolution and 1080p video resolution.

In some embodiments, the first electronic processor 205 is configured to display, on the display 230 of the playback device 110, a first plurality of refined hybrid images that each include at least one of (i) different gain values of the high pass filtered second image than each other and (ii) different sizes than each other. A first user input received by the playback device 110 can then indicate whether the user 135 perceives the second interpretation of the high pass filtered second image B (male) within one or more refined hybrid images of the first plurality of refined hybrid images. In some embodiments, the first user input is a series/sequence of one or more user inputs (e.g., a user input relating to the user's perception of each of the refined hybrid images displayed on the display 230). In some embodiments, a second user input is a series/sequence of one or more user inputs (e.g., a user input relating to the user's perception of each of additional refined hybrid images displayed on the display 230). The differences (i) and/or (ii) between different displayed refined hybrid images may be associated with a different test frequency for each refined hybrid image. Accordingly, based on the first user input received with respect to the first plurality of refined hybrid images (and/or additional user inputs with respect to additional refined hybrid images), the first electronic processor 205 may determine details of the vision capabilities of the user 135 in the viewing environment 130.

As an example of the refined hybrid images within the first plurality of refined hybrid images having different sizes than each other, the refined hybrid images of FIGS. 12A, 13A, and 14A may be displayed on the display 230 to determine whether the user 135 can perceive spatial frequencies respectively above 0.083 cpp (180p video resolution on a 1080p display), 0.167 (360p video resolution on a 1080p display), and 0.333 cpp (720p video resolution on a 1080p display). For any of these refined hybrid images, if the user 135 can perceive the high pass-filtered image B (male), then the user 135 can perceive spatial frequencies above the test frequency of the respective refined hybrid image.

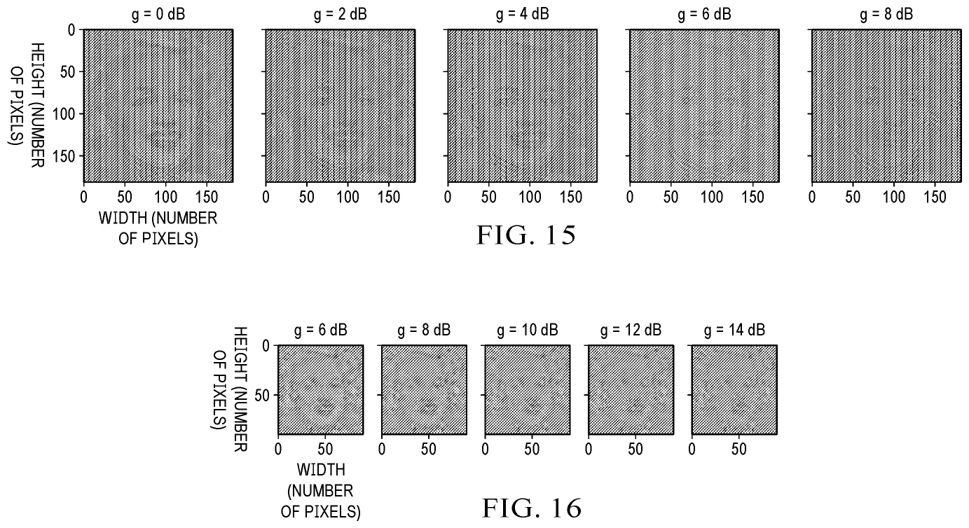

As an example of the refined hybrid images within the first plurality of refined hybrid images having gain values of the high pass filtered second image B that are different than each other, the first plurality of refined hybrid images may include refined hybrid images that are identical except for different gain values (g) of the high pass-filtered image B. For each subsequent refined hybrid image in the plurality of refined hybrid images, the first electronic processor 205 may increase the gain value (g) of the high pass-filtered image B included in the refined hybrid image. For example, FIGS. 15 and 16 each illustrate five refined hybrid images with increasing gain values for the high pass-filtered image B from left to right. Accordingly, the high pass-filtered image B (male) is least dominant in the left-most refined hybrid image of each of FIGS. 15 and 16 and is most dominant in the right-most refined hybrid image of each of FIGS. 15 and 16. If there exists a gain value that allows the user 135 to perceive the second interpretation of the high pass-filtered image B within any of the refined hybrid images shown respectively in FIGS. 15 and 16, the first electronic processor 205 determines that the user 135 can perceive spatial frequencies above the test frequency of the first plurality of refined hybrid images. On the other hand, if the user 135 cannot perceive the second interpretation of the high pass-filtered image B within any of the refined hybrid images shown respectively in FIGS. 15 and 16 (e.g., even in the right-most refined hybrid image where the gain of the high pass-filtered image B is the highest), the first electronic processor 205 determines that the user 135 cannot perceive spatial frequencies above the test frequency of the first plurality of refined hybrid images. In some embodiments, the refined hybrid images of FIG. 15 may be generated to test a test frequency (fₜₑₛₜ) of 540p and may use a second scaling factor (S′) of 0.5 while the refined hybrid images of FIG. 16 may be generated to test a test frequency (fₜₑₛₜ) of 720p and may use a second scaling factor (S′) of 0.25.

In some embodiments, each refined hybrid image in the plurality of refined hybrid images is displayed on the display 230 simultaneously. For example, the plurality of refined hybrid images are shown simultaneously in a row as shown in FIGS. 15 and 16. In such embodiments, the first electronic processor 205 may also control the display 230 to display instructions that indicate that the user 135 should select (e.g., with an input device) each refined hybrid image in which the high pass-filtered image B (male) is visible to the user 135. In some embodiments, the plurality of refined hybrid images may be displayed sequentially one after another. In such embodiments, the display 230 may again display instructions that indicate that the user 135 should indicate (e.g., with an input device) whether the high pass-filtered image B is visible to the user 135 in each refined hybrid image that is displayed. In some embodiments, the display 230 may begin by displaying a first refined hybrid image (e.g., the left-most image in the plurality of refined hybrid images shown in FIGS. 15 and 16). In some embodiments, the display 230 may also display instructions that indicate that the user 135 should adjust (e.g., with an input device) the refined hybrid image until the high pass-filtered image B is visible to the user 135.

In some embodiments, the first electronic processor 205 may adjust the displayed refined hybrid image to change the size of the refined hybrid image and/or a gain value of the high-pass filtered image B in response to a user input received via an input device of the playback device 110. For example, the display 230 may include a slider bar that the user 135 may control to control how the first electronic processor 205 controls the display/generation of the refined hybrid image. In some embodiments, the first electronic processor 205 may gradually and automatically adjust the displayed refined hybrid image until the playback device 110 receives a user input indicating that the user 135 perceives the high pass-filtered image B or until the playback device 110 receives a user input indicating that the user 135 cannot perceive the high pass-filtered image B at any point during the adjustments of the displayed refined hybrid image. In such embodiments, the adjusted parameter(s) of the displayed refined hybrid image may be reset after the adjusted parameter(s) is adjusted to a predefined limit. For example, after the right-most refined hybrid image of FIGS. 15 and 16 is displayed, the displayed refined hybrid image may be reset to display the left-most refined hybrid image of FIGS. 15 and 16. During display of the plurality of refined hybrid images, the display 230 may display an indicator of how one or more parameters of the refined hybrid image are being adjusted.

Based on the vision capabilities of the user 135 with respect to the first plurality of refined hybrid images that are displayed on the display 230 as determined by the first electronic processor 205 in response to the first user input received by the playback device 110, the first electronic processor 205 may generate/select a second plurality of hybrid images to narrow in on an estimated minmax QoE resolution for the user 135 in the environment 130. In some embodiments, in response to the first user input indicating that the first user perceives the second interpretation of the high pass filtered second image B within the one or more refined hybrid images of the first plurality of refined hybrid images, the first electronic processor 205 is configured to display, on the display of the playback device 110, a second plurality of refined hybrid images that are each smaller in size or larger in size than each of the first plurality of refined hybrid images. For example, a value of the scaled cutoff frequency (f_{c}S) may be determined by setting the cutoff frequency (f_{c}) to be the same as the Nyquist frequency of the second highest available video resolution (e.g., 720p on a 1080p display, e.g., f_{c}=720/2*1080=0.333 cpp according to Equation 2). In some embodiments, the first scaling factor(S) is empirically determined such that the scaled cutoff frequency (f_{c}S) becomes low enough to enable controlling the percept/interpretation of the hybrid image between the source image A and source image B through adjustment of the gain (g) of high pass filter used to filter the source image B (e.g., as shown in FIG. 15).

In some embodiments, the available video resolution of a media streaming application may be 360p, 540p, 720p, and 1080p on a 1080p display. Continuing the above example, the first electronic processor 205 may begin by testing the user's vision capabilities at 540p. In other words, the test frequency (fₜₑₛₜ) of the first plurality of refined hybrid images that are displayed on the display 230 is 540p (e.g., f_{cpp}=(0.5*540)/1080=0.25 cpp according to Equation 2). Accordingly, the second scaling factor (S′) is set to S′=(f_{c}S)/fₜₑₛₜ=720S/540 according to Equation 1 (where the first scaling factor(S) was previously empirically determined as described above). As explained previously herein, the first plurality of refined hybrid images may be displayed with increasing gain values (g) for the high pass-filtered second image B until a user input is received that indicates that the user 135 perceives the high pass-filtered second image B or until a user input is received that indicates that the user 135 does not perceive the high pass-filtered second image B (male) in any of the first plurality of refined hybrid images.

In response to the first user input indicating that the first user perceives the second interpretation of the high pass filtered second image B within the one or more refined hybrid images of the first plurality of refined hybrid images, the first electronic processor 205 is configured to display, on the display of the playback device 110, a second plurality of refined hybrid images that are each smaller in size than each of the first plurality of refined hybrid images. In other words, because there exists a gain value that makes the percept/interpretation of at least one of the first plurality of refined hybrid images to the user 135 as the high pass-filtered second image B (male), the first electronic processor 205 determines that the minmax QoE resolution of the user 135 in the environment 130 is higher than the test frequency (e.g., 540p in this example).

Accordingly, the first electronic processor 205 generates the second plurality of refined hybrid images to have a test frequency of the next highest available video resolution (e.g., 720p). In some embodiments, the first electronic processor 205 adjusts the size of the second plurality of hybrid images (e.g., makes the second plurality of images smaller compared to the first plurality of images) by adjusting the second scaling factor (S′) to S′=(f_{c}S)/fₜₑₛₜ=720S/720 according to Equation 1. The first electronic processor 205 may then repeat the display and testing process to determine whether the minmax QoE resolution of the user 135 in the environment 130 is higher than the second test frequency (e.g., 720p in this example). In some embodiments, the first electronic processor 205 is configured to receive a second user input from the first user 135. The second user input may indicate whether the first user 135 perceives the second interpretation of the high pass filtered second image B within one or more refined hybrid images of the second plurality of refined hybrid images. In some embodiments, the first electronic processor 205 is configured to determine, based at least in part on the second user input, the optimized value of the media parameter (e.g., a minmax QoE resolution of the user 135).

For example, in response to the second user input indicating that the first user 135 perceives the second interpretation of the high pass filtered second image B within one or more refined hybrid images of the second plurality of refined hybrid images, the first electronic processor 205 may determine that the minmax QoE resolution of the user 135 in the environment 130 is higher than the second test frequency (e.g., 720p in this example). Accordingly, the first electronic processor 205 may set the video resolution of media displayed on the playback device 110 to be 1080p. On the other hand, in response to the second user input indicating that the first user 135 does not perceive the second interpretation of the high pass filtered second image B within one or more refined hybrid images of the second plurality of refined hybrid images, the first electronic processor 205 may determine that the minmax QoE resolution of the user 135 in the environment 130 is less than the second test frequency (e.g., 720p in this example). Since the first electronic processor 205 has already determined that the minmax QoE resolution of the user 135 in the environment 130 is greater than 540p, the first electronic processor 205 may set the video resolution of media displayed on the playback device 110 to be 720p.

Returning back to the initial testing of the video resolution 720p, in response to the first user input indicating that the first user does not perceive the second interpretation of the high pass filtered second image B within the one or more refined hybrid images of the first plurality of refined hybrid images, the first electronic processor 205 is configured to display, on the display of the playback device 110, a third plurality of refined hybrid images that are each larger in size than each of the first plurality of refined hybrid images. In other words, because there does not exist a gain value that makes the percept/interpretation of at least one of the first plurality of refined hybrid images to the user 135 as the high pass-filtered second image B (male), the first electronic processor 205 determines that the minmax QoE resolution of the user 135 in the environment 130 is lower than the test frequency (e.g., 540p in this example).

Accordingly, the first electronic processor 205 generates the third plurality of refined hybrid images to have a test frequency of the next lowest available video resolution (e.g., 360p). In some embodiments, the first electronic processor 205 adjusts the size of the third plurality of hybrid images (e.g., makes the third plurality of images larger compared to the first plurality of images) by adjusting the second scaling factor (S′) to S′=(f_{c}S)/fₜₑₛₜ=720S/360 according to Equation 1. The first electronic processor 205 may then repeat the display and testing process to determine whether the minmax QoE resolution of the user 135 in the environment 130 is higher than the third test frequency (e.g., 360p in this example). In some embodiments, the first electronic processor 205 is configured to receive a third user input from the first user 135. The third user input may indicate whether the first user 135 perceives the second interpretation of the high pass filtered second image B within one or more refined hybrid images of the third plurality of refined hybrid images. In some embodiments, the first electronic processor 205 is configured to determine, based at least in part on the third user input, the optimized value of the media parameter (e.g., a minmax QoE resolution of the user 135).

For example, in response to the third user input indicating that the first user 135 perceives the second interpretation of the high pass filtered second image B within one or more refined hybrid images of the third plurality of refined hybrid images, the first electronic processor 205 may determine that the minmax QoE resolution of the user 135 in the environment 130 is higher than the third test frequency (e.g., 360p in this example). Accordingly, the first electronic processor 205 may set the video resolution of media displayed on the playback device 110 to be 540p because the first electronic processor 205 previously determined that the minmax QoE resolution of the user 135 is not greater than 540p. On the other hand, in response to the third user input indicating that the first user 135 does not perceive the second interpretation of the high pass filtered second image B within one or more refined hybrid images of the third plurality of refined hybrid images, the first electronic processor 205 may determine that the minmax QoE resolution of the user 135 in the environment 130 is less than the third test frequency (e.g., 360p in this example). Accordingly, the first electronic processor 205 may set the video resolution of media displayed on the playback device 110 to be 360p (e.g., the minimum video resolution of the display 230) because the user 135 cannot perceive the difference between 360p video and video displayed at higher resolutions.

As indicated by the above examples, the first electronic processor 205 may determine an optimized value of a media parameter for streaming output media over the network 115 and/or displaying output media on the playback device 110. For example, the optimized value of the media parameter may be a value of a minimum resolution for maximum quality of experience (minmax QoE resolution) that is personalized for the first user 135 based at least in part on the first user input as explained previously herein. As another example, the optimized value of the media parameter may be a value of an estimated quality of experience (QoE) transfer function that is personalized for the first user 135 based at least in part on the first user input as explained below. As other examples, the optimized value of the media parameter may be a value of a bit rate or a frame rate of media streaming from the media server 105 over the network 115 that is based on the minmax QoE resolution or the QoE transfer function. The optimized value of the media parameter may be a value of other media parameters that are based on the minmax QoE resolution or the QoE transfer function.

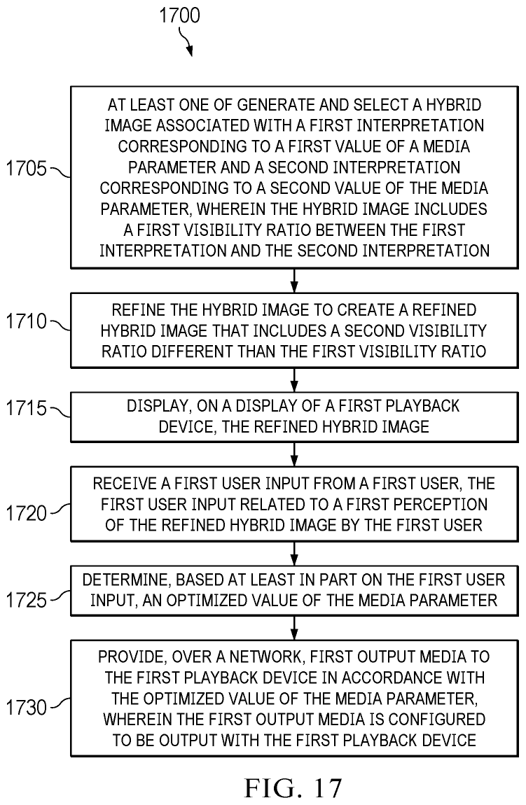

FIG. 17 illustrates a flowchart of a method 1700 that may be performed by an electronic computing device to generate hybrid images for use in capturing personalized playback-side context information of a user 135 in the environment 130 and providing output media to a playback device in accordance with the personalized playback-side context information according to an example embodiment. The method 1700 is a generalized method that may represent any of the one or more of the specific example implementations of refined hybrid image generation described previously herein. The method 1700 may be implemented by one or more electronic processors of the electronic computing device. As explained previously herein, the electronic computing device may be a single device or a combination of multiple devices (e.g., the media server 105, the playback device 110, etc.).

At block 1705, one or more electronic processors of the electronic computing device at least one of generate and select a hybrid image associated with a first interpretation corresponding to a first value of a media parameter and a second interpretation corresponding to a second value of the media parameter. In some embodiments, the hybrid image includes a first visibility ratio between the first interpretation and the second interpretation. As explained previously herein, the first interpretation may be generated based on a first source image A (e.g., see FIG. 4A) that is low pass-filtered. The second interpretation may be generated based on a second source image B (e.g., see FIG. 4B) that is high pass-filtered. While the one or more electronic processors may generate the hybrid image, the one or more electronic processors may additionally or alternatively select a previously generated hybrid image.

In some embodiments, the first interpretation may correspond to the first value of the media parameter such that the first interpretation of the low pass-filtered first image A is visible to the user 135 if the user 135 has vision capabilities in the environment 130 that correspond to the first value of the media parameter. Similarly, the second interpretation may correspond to the second value of the media parameter such that the second interpretation of the high pass-filtered second image B is visible to the user 135 if the user 135 has vision capabilities in the environment that correspond to the second value of the media parameter. For example and as described previously herein in numerous examples, the first interpretation of the low pass-filtered first image A may correspond to a video resolution/spatial frequency below a test frequency (e.g., below 720p video resolution on a 1080p display), and the second interpretation of the high pass-filtered second image B may correspond to a video resolution/spatial frequency above the test frequency (e.g., above 720p video resolution on a 1080 display).

In some embodiments, a ratio between how visible the first interpretation of the low pass-filtered image A is in the hybrid image and how visible the second interpretation of the high pass-filtered image B is in the hybrid image is referred to as the visibility ratio. In other words, the visibility ratio may be a comparison of how visible each of the two interpretations/percepts in the hybrid image is to the human eye (e.g., to a person with 20/20 vision and no vision diseases/disorders). For example, the visibility ratio may be different for different hybrid images depending on one or more of (i) a cutoff frequency of one or both of the filters use to filter each of the source images A and B. (ii) a gain of one or both of the filters use to filter each of the source images A and B, and (iii) a size of the hybrid image that is displayed on the display 230.

At block 1710, the one or more electronic processors are configured to refine the hybrid image to create a refined hybrid image that includes a second visibility ratio different than the first visibility ratio. For example, as described previously herein, the hybrid image may be refined by adjusting one or more of (i) the cutoff frequency of one or both of the filters use to filter each of the source images A and B. (ii) the gain of one or both of the filters use to filter each of the source images A and B, and (iii) the size of the hybrid image that is displayed on the display 230. For example, the hybrid image may be adjusted according to Equation 1 to generate a refined hybrid image that tests a desired test frequency associated with a media parameter (e.g., a video resolution) such that the high pass-filtered image B is visible to a user 135 when displayed on the display 230 if the user's vision capabilities are high enough.

In some embodiments, after the refining block 1710 is performed, the second visibility ratio of the refined hybrid image is closer to one-to-one than the first visibility ratio of the hybrid image. For example, the initial/unrefined hybrid image may be dominated by the low pass-filtered image A such that even large gain values of the high pass-filtered second image B do not allow the high pass-filtered second image B to be visible by human eyes in most viewing situations. However, the refined hybrid image may be less dominated by the low pass-filtered image A (e.g., the second visibility ratio is closer to one-to-one than the first visibility ratio) such that the high pass-filtered image B is visible to a user 135 when displayed on the display 230 if the user's vision capabilities are high enough. In some embodiments, the first visibility ratio of the initial/unrefined hybrid image is closer to one-to-one than the second visibility ratio of the refined hybrid image. In some embodiments, the first visibility ratio of the initial/unrefined hybrid image and the second visibility ratio of the refined hybrid image differ relative to separate reference values (e.g., a default ratio value, a target ratio value that may be predetermined to provide a balanced hybrid image where both interpretations of the source images A and B are visible depending on viewing conditions and viewing capabilities of a human user with, for example, 20/20 vision and no vision diseases or disorders, etc).

At block 1715, the one or more electronic processors control the display 230 of the playback device 110 to display the refined hybrid image. At block 1720, the one or more electronic processors receive a first user input from a first user 135 via an input device of the playback device 110. In some embodiments, the first user input is related to a first perception of the refined hybrid image by the first user 135. As indicated by previously explained examples, the first user input may indicate whether the first user 135 is able to perceive the high pass-filtered image B associated with the displayed refined hybrid image.

At block 1725, the one or more electronic processors determine, based at least in part on the first user input, an optimized value of the media parameter (e.g., a minmax QoE resolution, a minmax QoE resolution range, a point on an estimated QoE transfer function, and or the like). For example and as described previously herein, the one or more electronic processors may determine that the vision capabilities of the user 135 in the environment 130 are such that the user 135 cannot discern a difference between 720p video and 1080p video. In response thereto, the one or more electronic processors may set the maximum video resolution of the display 230 and of any requested media from the media server 105 not to exceed 720p video resolution (e.g., video resolution values should remain in a range below 720p). In some embodiments, the one or more electronic processors may determine that the vision capabilities of the user 135 in the environment 130 are such that the user 135 can discern a difference between 720p video and lesser video resolutions. In response thereto, the one or more electronic processors may set the desired video resolution of the display 230 and of any requested media from the media server 105 to be 720p video resolution when such video is available (e.g., the video resolution should remain at 720p when possible for maximum QoE for the user 135).

At block 1730, the one or more electronic processors provide, over the network 115, first output media to the first playback device 110 in accordance with the optimized value of the media parameter determined at block 1725. In some embodiments, the first output media is configured to be output with the first playback device 110 for consumption by the user 135. For example, the first playback device 110 may request the first output media from the media server 105 in accordance with the optimized value of the media parameter (e.g., in accordance with the minmax QoE resolution of the user 135 in the environment 130, the minmax QoE resolution range of the user 135 in the environment 130, the estimated QoE transfer function, and or the like). In some embodiments, the playback device 110 may request the first output media of, for example, a specific quality/bit rate in accordance with the optimized value of the media parameter determined at block 1725.

As described in PCT Application No. PCT/US2020/044241, filed Jul. 30, 2020, now International Publication No. WO 2021/025946, the entire contents of which are hereby incorporated by reference, sharing parameters related to playback device characteristics and personalized visual-sensitivity factors with the upstream devices configured to control the transmission of visual media to the playback devices can provide personalized and adaptive media delivery based on collected playback-side information often without using individual sensors. Additionally, the collected playback-side information may be indicative of personalized quality of experience (QoE) for different users and/or different viewing environments. Accordingly, there may be improvements in network resource management/media delivery efficiency while maintaining personalized QoE for each user. Continuing the above example, the video resolution of the video being output on the first playback device 110 of the first user 135 may be reduced to and/or maintained at 720p video resolution instead of 1080p video resolution without affecting the QoE of the first user 135.

As described previously herein and also as described in PCT Application No. PCT/US2020/044241, in the visual media delivery chain, adaptive bit rate (ABR) streaming allows for improved network resource management through adaptive selection of bit rate and resolution on a media ladder based on network conditions, playback buffer status, shared network capacity, and other factors influenced by the network. Besides ABR streaming, other media delivery methods (which also may include coding methods or source coding methods) may similarly be used to control one or more media parameters of an upstream video encoder/transcoder/transrater such as bit rate, frame rate, resolution, etc. (including other examples explained previously herein).

Many of the previous example implementations of the method 1700 provided herein relate to determining an estimated minmax QoE video resolution or an estimated minmax QoE video resolution range associated with the user 135. The following explanation and examples relate to determining a shape of an estimated QoE transfer function for the user 135 rather than merely determining visibility capabilities of the user 135 beyond a certain frequency/video resolution. In some embodiments, the QoE transfer function is indicative of a total QoE of the user that takes into account numerous aspects of the transfer, processing, display, and/or consumption of the visual media (e.g., output media) from the signal pathway over which the visual media is provided to the playback device 110 to the digital representation of the visual media and until the user 135 consumes/views the visual media. In other words, the QoE transfer function may be indicative of a net effect of whole playback-side context information. In some embodiments, the playback-side context information includes an effect of playback systems 110 (such as display characteristics), environment 130 (such as ambient lighting conditions and viewing distance), and human observers 135 (such as the characteristics of visual sensitivity of the person under test). In some embodiments, the QoE transfer function is representative of multiple functions that include a contrast sensitivity function (CSF) of the user 135, a modulation transfer function (MTF) of the display 230 used to display the visual media, and/or other functions indicative of quality of the visual media being displayed to the user 135. In some embodiments, a CSF indicates a relationship between contrast sensitivity of the user 135 in the environment 130 with respect to spatial frequency/video resolution of the display 230. The CSF of a user 135 is explained in further detail in PCT Application No. PCT/US2020/044241. In some embodiments, the MTF represents a frequency response of the display 230. The below explanations refer to the CSF, but it should be understood that the CSF is merely one function that may affect the overall QoE transfer function of the user 135 in the environment 130. In some embodiments, the CSF of the user 135 is the primary function that affects the QoE transfer function of the user 135.

In some embodiments, to estimate a magnitude value (in dB) of a QoE transfer function of the user 135 in the environment 130, some assumptions may be made. First, it may be assumed that the perception of the refined hybrid image by the user 135 (e.g., which source image A or B is perceived as dominant by the user 135) is determined by a comparison/visibility of the sums of weighted power spectra (e.g., a CSF-weighted power spectra) of the low pass-filtered first image A and the high pass-filtered second image B. Second, it may be assumed that a masking effect is negligible due to sufficient separation of the two spectra of the source images A and B.

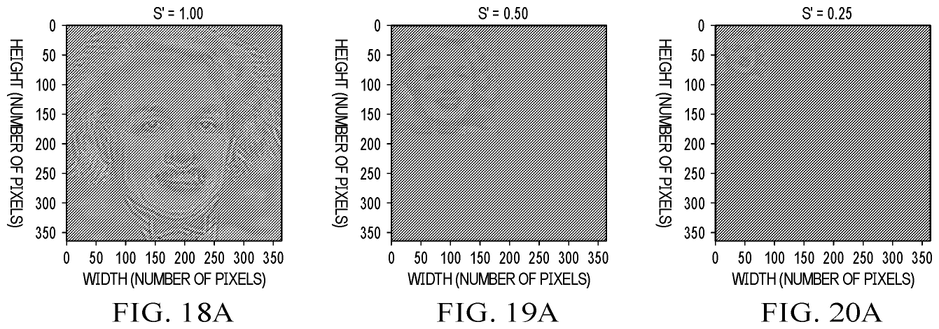

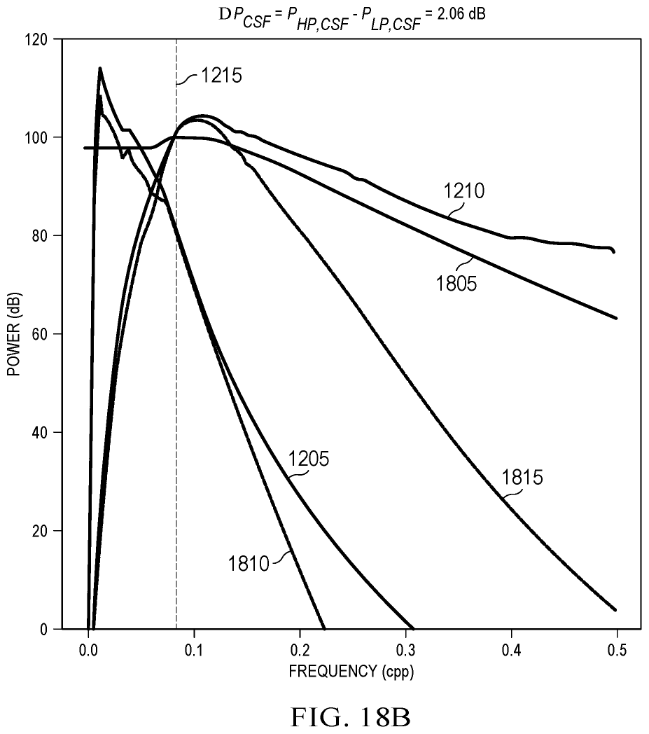

To illustrate the effect of an example CSF of the user 135, FIGS. 18B, 19B, and 20B illustrate a presumed CSF 1805, 1905, 2005 of the user 135 at 3H viewing distance (e.g., a viewing distance of three time a height of the display 230). Additionally, FIGS. 18B, 19B, and 20B illustrate a first CSF-weighted power spectra 1810, 1910, 2010 for the low pass-filtered first image A (female) and a second CSF-weighted power spectra 1815, 1915, 2015 for the high pass-filtered second image (male). In FIGS. 18B, 19B, and 20B, the curves mentioned above are shown in conjunction with the contents of FIGS. 12B, 13B, and 14B. In fact, FIGS. 18A, 19A, and 20A illustrate the same three example refined hybrid images that are shown in FIGS. 12A, 13A, and 14A. The graphs of FIGS. 18B, 19B, and 20B correspond to the respective hybrid images shown in FIGS. 18A, 19A, and 20A. In each of the hybrid images shown in FIGS. 18A, 19A, and 20A, a sum of the power spectra of the two source images A and B are set to be approximately equal. In some embodiments, a logarithm of the example presumed CSF 1805, 1905, 2005 may be represented by a simplified version of a truncated log-parabola form as shown in Equation 3 below with sfₘₐₓ=5.28, β=1.30, δ=0.23, and where f represents spatial frequency in cycle per degree. The values noted above are example values for representing an example CSF 1805, 1905, 2005. Additionally, Equation 3 is merely one example equation to represent a parametric form of a CSF of the user 135 to demonstrate how image spectra are weighted by the CSF. In some embodiments, Equation 3 may use different values for the one or more constants. In some embodiments, a parametric form of the CSF of the user 135 may be represented by a different equation.

$$C ( f ) = \{ \begin{matrix}- {{log}_{10} ( 2 ) [ \frac{{log}_{10} ( f ) - {log}_{10} ( {sf}_{m ax} )}{\frac{{log}_{10} ( 2 β )}{2}} ]}^{2} if f \geq {sf}_{ma x} \\ - δ if f < {sf}_{max} and C ( f ) < - δ\end{matrix} \qquad Equation 3$$

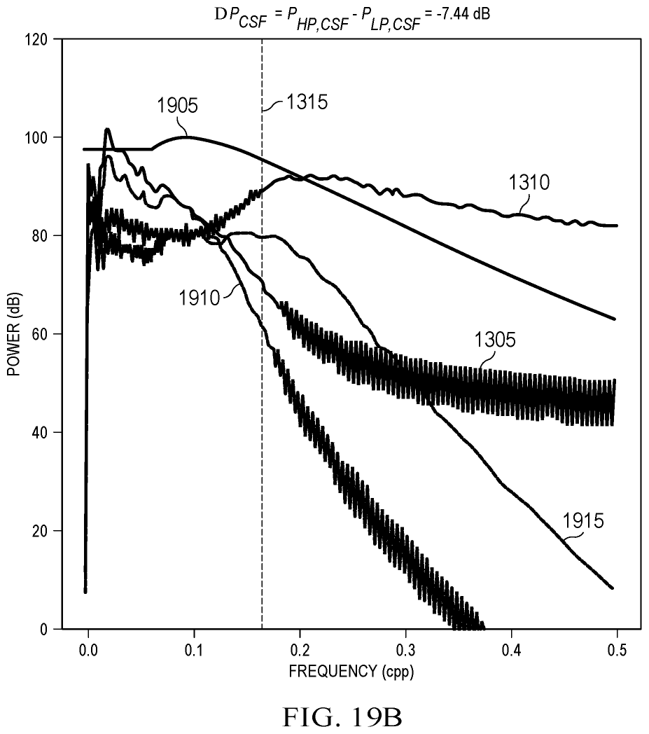

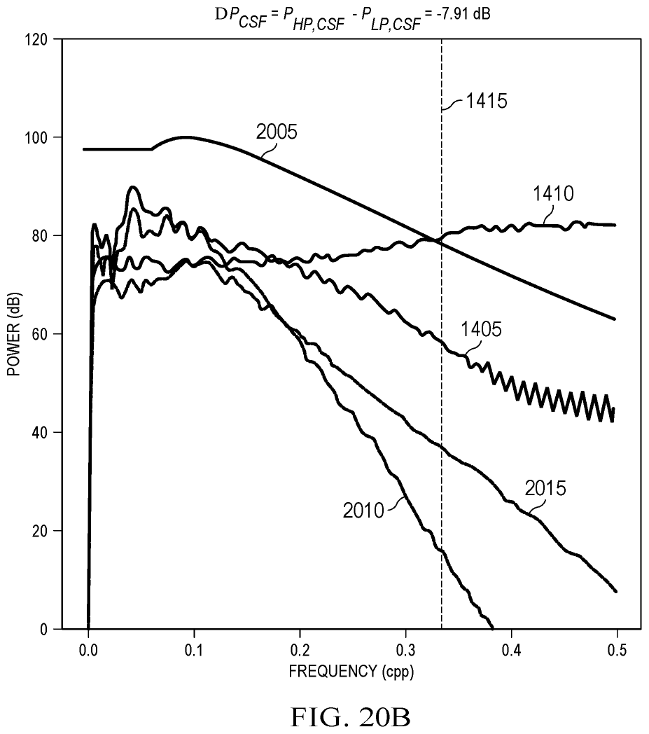

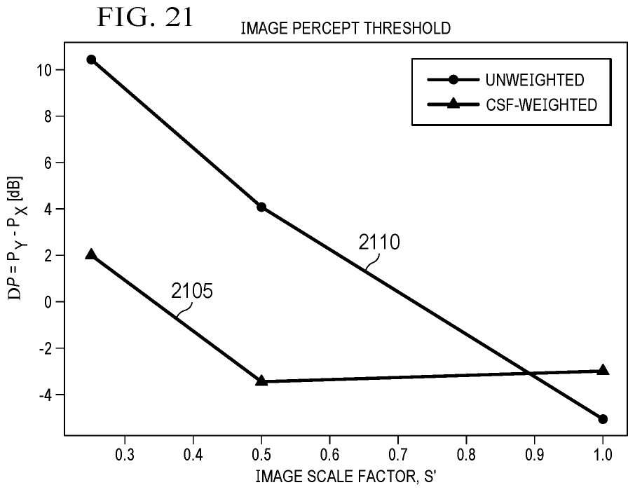

At the top of FIGS. 18B, 19B, and 20B, a difference between the sum of the CSF-weighted power of the high pass-filtered second image B (male) and the CSF-weighted power of the low pass-filtered first image A (female) is represented as ΔP_{CSF} (e.g., the sum of the areas under each curve 1810 and 1815, 1910 and 1915, and 2010 and 2015). For FIGS. 18A and 18B, the weighted power of the high pass-filtered second image is larger than that of the low pass-filtered first image (e.g., ΔP_{CSF}=2.06 dB). Accordingly, the percept/interpretation of the refined hybrid image shown in FIG. 18A may be dominated by the high pass-filtered second image for most human observers of the refined hybrid image. In other words, most human observers (e.g., a user 135 with 20/20 vision and no vision diseases/disorders) perceive the high pass-filtered second image instead of the low pass-filtered first image. As the size of the refined hybrid image is reduced (e.g., as shown in FIGS. 19A and 20A), the weighted power of low pass-filtered first image becomes larger than that of high pass-filtered second image as indicated in FIGS. 19B and 20B (e.g., ΔP_{CSF}=−7.44 dB and −7.91 dB in FIGS. 19B and 20B. respectively). Accordingly, the perceptual dominance of the refined hybrid image for most human observers changes from the high pass-filtered second image in FIG. 18A to the low pass-filtered first image in FIGS. 19A and 20A.

In some embodiments, the percept/interpretation of the refined hybrid image may be controlled by adjusting the gain (g) of the high pass-filtered second image B as explained previously herein as long as perceptually important portions of the image spectra of both source images A and B are in visible range of the user 135 in at least some viewing conditions. A variable g′ may be defined as the gain of the high pass-filtered image B where the image percept/interpretation switches between the low pass-filtered hybrid first image A and the high pass-filtered second image B. Because of different vision capabilities and different environments, g′ may be different for different users 135 in different environments 130.

In some embodiments, the first electronic processor 205 determines g′ for a first user 135 in a first environment 130 by calculating a mid-point gain g′ between a measured variable g⁺ and a measured variable g⁻. In some embodiments, g⁻ is a measured gain (g) at which the user 135 no longer perceives the low pass-filtered first image A as the gain (g) of the high pass-filtered second image B is increased. In some embodiments, g⁺ is a measured gain (g) at which the user 135 no longer perceives the high pass-filtered second image B as the gain (g) of the high-pass filtered second image B is decreased. In some embodiments, during the increasing and decreasing of the gain (g) of the high-pass filtered second B, a second gain of the low pass-filtered first image A may remain constant.

An experiment was performed to measure g′ for the refined hybrid images shown in FIGS. 18A, 19A, and 20A with a user 135 at 3H viewing distance. FIG. 21 is a graph of results of the experiment that shows ΔP=P_{HP-filtered image}−P_{LP-filtered image} (in dB) when the gain (g)=g* (e.g., the gain g* where the perception of the refined hybrid images of FIGS. 18A, 19A, and 20A by the user 135 changed from the high-pass filtered second image to the low pass-filtered first image). In some embodiments, P_{HP-filtered image} is the sum of power spectrum of the high pass-filtered second image in dB, and P_{LP-filtered image} is the sum of power spectrum of the low pass-filtered first image in dB. FIG. 21 illustrates an unweighted ΔP curve 2110 and a CSF-weighted ΔP curve 2105 both as a function of the second scale factor S′ for different refined hybrid image sizes. Each curve 2105, 2110 is based on three g′ points respectively corresponding to the refined hybrid images of FIGS. 18A, 19A, and 20A. Although a presumed CSF is used without taking into account all factors affecting the actual CSF of the user 135 in the experiment, it can be seen that the CSF-weighted ΔP curve 2105 is closer to zero dB and more invariant to the image size (e.g., the second scaling factor S′) than the unweighted ΔP curve 2110.

From the data shown in FIG. 21, an assumption may be made that the use of a predefined CSF rather than using a personalized CSF tuned to the specific user 135 is a major contributing factor to the deviation of the CSF-weighted ΔP curve 2105 from zero dB. This assumption may be accordingly extended to develop a new method to estimate the CSF of a user 135 (or a QoE transfer function at least partially based on the CSF of a user 135) from a set of measured mid-point gain values g′. As shown in FIG. 21, the results of the experiment demonstrate the validity of using a CSF-weighted power spectra rather than using a raw power spectra of images to represent the mid-point gain g′ obtained from actual human subjects/users (e.g., because the CSF-weighted ΔP curve 2105 is closer to zero dB than the unweighted ΔP curve 2110). It should be noted that the CSF used in the calculations of the ΔP values in FIG. 21 is not the actual CSF of a user 135. Rather, the CSF used in the calculations of the ΔP values in FIG. 21 is a presumed CSF used for experimental purposes. If the actual CSF of the user 135 was used, the CSF-weighted ΔP curve 2105 may be even closer to zero dB.

In some embodiments, N refined hybrid images with different second scaling factors S′ are prepared and presented to the user 135 to measure g′ for each refined hybrid image. As the difference between the sum of power spectrum of high pass-filtered second image B and the low pass-filtered first image A in the refined hybrid image is minimal when the gain g=g′, the optimal CSF in the mean squared error-sense may be estimated by minimizing a cost function J with respect to the parameter set θ using gradient descent as defined by Equation 4 below. In some embodiments, a goal of displaying refined hybrid images and receiving user inputs regarding the refined hybrid images is to find a desired parameter set (from the mid-point g′ measured from the user 135 (e.g., which value of g′ provides an image percept change to the user 135) given known source images A and B used to generate the refined hybrid images.

$$J = {( {\sum }_{n} {\sum }_{k} )}^{- 1} {\sum }_{n} {{\sum }_{k} [ ( {g}_{n}^{′} {Y}_{n} ( k ) - {X}_{n} ( k ) ) {10}^{C ( k \vert θ} ]}^{2} = {( {\sum }_{n} {\sum }_{k} )}^{- 1} {‖ {Q}^{t} \cdot c ( θ ) ‖}^{2} \qquad Equation 4$$

$$where$$

$$c ( θ ) = 1 {0}^{C ( k \vert θ )} ,$$

$$θ = \{ {sf}_{m ax} , β , δ \}$$

$$Q = [ \begin{matrix}{q}_{1} & {q}_{2} & … & {q}_{n}\end{matrix} ]$$

$${q}_{n} = {g}_{n}^{′} {P}_{HP - filtered image} - {P}_{LP - filtered image}$$

$${P}_{LP - filtered image} = {[ {X}_{n} ( 0 ) , {X}_{n} ( 1 ) , … , {X}_{n} ( K - 1 ) ]}^{T}$$

$${θ}^{′} = arg {min}_{θ} J ( θ )$$

In some embodiments, in Equation 4, k=0, 1 . . . , K−1, is the discrete frequency index, and n=0, 1 . . . , N−1 is the image sample index. For example, the power spectrum of frequency (e.g., along the x-axis in FIG. 18B) may include K discrete components where K covers the frequency range 0.0 cpp to 0.5 cpp. In some embodiments, N may be the number of refined hybrid images presented to the user 135 to obtain the corresponding N gain switching values g′ (e.g., mid-point gain values g′).

In some embodiments, the use of Equation 4 in combination with user inputs received with respect to refined hybrid images displayed on the display 230 allows the first electronic processor 205 to determine a mid-point gain value g′ with respect to each refined hybrid image for which a user input is received that indicates when the perception of the refined hybrid image to the user 135 changes from the high pass-filtered second image B to the low pass-filtered first image A as the gain (g) of the high pass-filtered second image B is changed. The spatial frequency of the refined hybrid image in cycles per pixel (cpp) is known from the generation/selection of the refined hybrid image as explained previously herein (e.g., see Equations 1 and 2). Therefore, for each refined hybrid image for which the user 135 indicates the mid-point gain value g′, the first electronic processor 205 may plot the magnitude (in dB) of the mid-point gain value g′ against the spatial frequency to generate a point on an estimated QoE transfer function of the user 135. In some embodiments, the estimated QoE transfer function may approximate the CSF of the user 135.

In some embodiments, the first electronic processor 205 is configured to increase the gain (g) of the high pass filtered second image B within a displayed refined hybrid image while the refined hybrid image is displayed on the display 230. As explained above, the gain of the high pass filtered second image B may be increased until a first user input indicates that the first interpretation of the low pass-filtered first image A is no longer perceptible to the first user 135. In response to receiving the first user input that indicates that the first interpretation of the low pass-filtered first image A is no longer perceptible to the first user 135, the first electronic processor 205 may cease increasing the gain (g) of the high pass filtered second image within the refined hybrid image and record a first gain value (g−) corresponding to the gain of the high pass-filtered second image B when the first user input was received that indicated that the first interpretation is no longer perceptible to the first user 135. In some embodiments, the first electronic processor 205 may optionally reset the gain (g) of the high pass filtered second image B within the refined hybrid image to an original gain value that was used when the refined hybrid image was initially displayed on the display 230.

In some embodiments, the first electronic processor is configured to decrease the gain (g) of the high pass-filtered second image B within the refined hybrid image while the refined hybrid image is displayed on the display 230. The gain (g) of the high pass-filtered second image B may be decreased until a second user input indicates that the second interpretation of the high pass-filtered second image B is no longer perceptible to the first user 135. In response to receiving the second user input indicating that the second interpretation of the high pass-filtered second image B is no longer perceptible to the first user, the first electronic processor 205 is configured to cease decreasing the gain (g) of the high pass-filtered second image B within the refined hybrid image and record a second gain value (g⁺) corresponding to the gain (g) of the high pass-filtered second image B when the second user input was received that indicated that the second interpretation is no longer perceptible to the first user 135.

In some embodiments, the first electronic processor 205 is configured to determine a mid-point gain (g′) where a perception of the refined hybrid image by the first user 135 changes from the first interpretation to the second interpretation. In some embodiments, the mid-point gain (g′) is determined by applying a blending or weighting function to the first gain value (g⁻) and the second gain value (g⁺). For example, Equation 5 (below) indicates that there may be a first weighting (w) for the gain of the first image A and a second weighting (1-w) for the second image B.

$$Weighted Hybrid Image = wA + ( 1 - w ) B \qquad Equation 5$$

In some embodiments, the mid-point gain (g′) is the literal mid-point/arithmetic mean of the two source images A and B such that the source images A and B have equal weighting in the hybrid image. In some embodiments, the mid-point gain (g′) is not the literal mid-point/arithmetic mean of the two source images A and B such that the source images A and B are weighted differently in he hybrid image. In some embodiments, the first electronic processor 205 is configured to determine a magnitude value (in dB) of an estimated quality of experience (QoE) transfer function that is personalized for the first user 135. In some embodiments, the magnitude value is associated with a first test frequency (fₜₑₛₜ) used to generate at least one of the low pass-filtered first image A and the high pass-filtered second image B as explained previously herein. For example, the test frequency may include one of the first cutoff frequency of the low pass filter used to generate the low pass-filtered first image A and the second cutoff frequency of the high pass filter used to generate the high pass-filtered second image B.

In some embodiments, the above-noted actions to determine the magnitude value of the estimated QoE transfer function for a certain test frequency may be repeated by the first electronic processor 205 to determine a plurality of magnitude values and corresponding test frequencies. For example, the first electronic processor 205 may be configured to display a predetermined number of refined hybrid images and generate the predetermined number of points on the estimated QoE transfer function of the user 135. In some embodiments, the first electronic processor 205 may be configured to display a plurality of refined hybrid images and generate a plurality of points on the estimated QoE transfer function of the user 135 until the user 135 ends a training session on the playback device 110.

In some embodiments, the QoE transfer function is associated with the user 135 in the environment 130. In other words, a quantified value of the viewing capabilities of the user 135 at various spatial frequencies may be recorded and plotted for use by the first electronic processor 205 when requesting visual media from the media server 105 and when displaying the visual media on the display 230. For example, as explained above and in PCT Application No. PCT/US2020/044241, the first electronic processor 205 may reduce the quality of visual media output on the playback device 110 to a level that cannot be perceived by the user based on the QoE transfer function of the user. This results in improvements in network resource management/media delivery efficiency while maintaining personalized QoE for each user.

One advantage of estimating the QoE transfer function of a particular user 135 in a particular environment 130 is whole CSF estimation rather than a simple minmax QoE resolution as described in previous embodiments. The whole CSF estimation may allow the playback device 110 to overcome the challenge of using too small of refined hybrid images for display to the user 135 during execution of the methods describe previously herein. For example, when determining a minmax QoE resolution of the user according to previous embodiments described herein, a refined hybrid image may be too small for the user 135 to see on the display 230 and the percept/interpretation of the high pass-filtered second image B may be very weak even with a very high gain value due to the small image size. These technical problems are especially true when the cutoff frequency (f_{c}) of the filters is high. However, this technical problem/challenge may be addressed by using the parameterized QoE transfer function calculation that allows for accurate estimation of the CSF of the user 135 at various spatial frequencies without making the size of the refined hybrid images that are displayed on the display 230 too small. In other words, the methods used during generation of the estimated QoE transfer function allow for generation of data that relates to the vision capabilities of the user 135 at very high frequency ranges that may be difficult to measure using the methods to determine minmax QoE resolution that were explained previously herein. For example, with reference to the hybrid images of FIGS. 18A, 19A, and 20A, to test the minmax QoE resolution of the user 135 at a high spatial frequency (e.g., a test frequency of 0.333 cpp, which corresponds to 720p on a 1080p display) may involve generation of a small hybrid image as shown in FIG. 20A compared to testing of the minmax QoE resolution of the user 135 at lower spatial frequencies as shown in FIGS. 18A and 19A. However, when estimating the transfer function of Equation 4 (which may be equivalent to fitting a shape of the CSF curve 1805 of FIG. 18B using data points generated along the frequency axis (e.g., x-axis)), it may be sufficient to use hybrid images that span in size from that shown in FIG. 18A to that somewhere in between a size of the hybrid image shown in FIG. 19A and a size of the hybrid image shown in FIG. 20A. Accordingly, in some embodiments, a hybrid image as small as the hybrid image shown in FIG. 20A may not be displayed to the user 135 because the presumed CSF 1805 of the user may be able to be calculated without displaying such a small hybrid image. Yet another advantage of estimating the QoE transfer function of the user 135 is that this approach may be extended to incorporate different hybrid images in the same QoE transfer function estimation procedure all together.

In some embodiments, increasing the gain of the high pass filtered second image B within the refined hybrid image while the refined hybrid image is displayed on the display 230 is performed in response to a third user input that controls the gain (g) of the high pass filtered second image B within the refined hybrid image while the refined hybrid image is displayed on the display 230. In some embodiments, decreasing the gain of the high pass filtered second image B within the refined hybrid image while the refined hybrid image is displayed on the display 230 is performed in response to a fourth user input that controls the gain (g) of the high pass filtered second image B within the refined hybrid image while the refined hybrid image is displayed on the display 230. For example, the display 230 may include a slider bar input that is operable by the user 135 to control the gain (g) of the high pass-filtered second image B.

In some embodiments, increasing the gain of the high pass filtered second image B within the refined hybrid image while the refined hybrid image is displayed on the display 230 includes displaying a first plurality of refined hybrid images that each include different gain values of the high pass filtered second image B than each other (e.g., see FIG. 15). In some embodiments, the first user input that indicates that the first interpretation of the low pass-filtered first image A is no longer perceptible to the first user 135 includes a first selection of a first refined hybrid image of the first plurality of refined hybrid images in which the first interpretation of the low pass-filtered first image A is no longer perceptible to the first user 135. In some embodiments, decreasing the gain of the high pass filtered second image B within the refined hybrid image while the refined hybrid image is displayed on the display 230 includes displaying a second plurality of refined hybrid images that each include different gain values of the high pass filtered second image B than each other. In some embodiments, the second user input that indicates that the second interpretation of the high pass-filtered first image B is no longer perceptible to the first user 135 includes a second selection of a second refined hybrid image of the second plurality of refined hybrid images in which the second interpretation of the high pass-filtered first image B is no longer perceptible to the first user 135.

It is to be understood that the embodiments are not limited in its application to the details of the configuration and arrangement of components set forth herein or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising.” or “having” and variations thereof are meant to encompass the items listed thereafter and equivalents thereof as well as additional items. Unless specified or limited otherwise, the terms “mounted.” “connected.” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software based devices, as well as a plurality of different structural components, may be utilized to implement the embodiments. For example, “servers” and “computing devices” described in the specification can include one or more electronic processors, one or more computer-readable medium modules, one or more input/output interfaces, and various connections (e.g., a system bus) connecting the various components.

Throughout this application, the term “approximately” is used to describe the dimensions of various components. In some situations, the term “approximately” means that the described dimension is within 1% of the stated value, within 5% of the stated value, within 10% of the stated value, or the like. When the term “and/or” is used in this application, it is intended to include any combination of the listed components. For example, if a component includes A and/or B, the component may include solely A, solely B, or A and B.

Various aspects of the present invention may be appreciated from the following enumerated example embodiments (EEEs):

EEE1. A method comprising:
at least one of generating and selecting, with one or more electronic processors, a hybrid image associated with a first interpretation corresponding to a first value of a media parameter and a second interpretation corresponding to a second value of the media parameter, wherein the hybrid image includes a first visibility ratio between the first interpretation and the second interpretation;
refining, with the one or more electronic processors, the hybrid image to create a refined hybrid image that includes a second visibility ratio different than the first visibility ratio;
displaying, on a display of a first playback device, the refined hybrid image;
receiving, with the one or more electronic processors, a first user input from a first user, the first user input related to a first perception of the refined hybrid image by the first user;
determining, with the one or more electronic processors and based at least in part on the first user input, an optimized value of the media parameter; and
providing, over a network, first output media to the first playback device in accordance with the optimized value of the media parameter, the first output media configured to be output with the first playback device.

EEE2. The method of EEE 1, wherein the optimized value of the media parameter includes an approximate minimum resolution for approximate maximum quality of experience (minmax QoE resolution) that is personalized for the first user based at least in part on the first user input.

EEE3. The method of any one of the preceding EEEs, wherein the optimized value of the media parameter includes an estimated quality of experience (QoE) transfer function that is personalized for the first user based at least in part on the first user input.

EEE4. The method of any one of the preceding EEEs, wherein refining the hybrid image to create the refined hybrid image includes
scaling, by a first factor(S), a first cutoff frequency of a low pass filter used to filter a first image to a first scaled cutoff frequency, wherein the first cutoff frequency is selected based on the first value and the second value of the media parameter;
scaling, by the first factor, a second cutoff frequency of a high pass filter used to filter a second image to a second scaled cutoff frequency, wherein the second cutoff frequency is selected based on the first value and the second value of the media parameter;
filtering the first image with the low pass filter at the first scaled cutoff frequency to generate a low pass-filtered first image;
filtering the second image with the high pass filter at the second scaled cutoff frequency to generate a high pass-filtered second image;
combining the low pass-filtered first image and the high pass-filtered second image to generate a scaled cutoff frequency filtered hybrid image, wherein the low pass-filtered image provides the first interpretation, and wherein the high pass-filtered second image provides the second interpretation; and
scaling, by a second factor (S′), a size of the scaled cutoff frequency filtered hybrid image configured to be displayed on the display to a scaled size to generate the refined hybrid image.

EEE5. The method of EEE 4, wherein the first factor and the second factor are equivalent.

EEE6. The method of EEE 4 or EEE 5, wherein the first cutoff frequency and the second cutoff frequency are equivalent.

EEE7. The method of any one of EEEs 4-6, wherein refining the hybrid image to create the refined hybrid image further includes at least one of
adjusting a gain of the low pass-filtered first image to control the first interpretation of the low pass-filtered first image within the refined hybrid image; and
adjusting a gain of the high pass-filtered second image to control the second interpretation of the high pass-filtered second image within the refined hybrid image.

EEE8. The method of EEE 7, further comprising displaying, on the display of the first playback device, a first plurality of refined hybrid images that each include at least one of (i) different gain values of the high pass-filtered second image than each other and (ii) different sizes than each other;
wherein the first user input indicates whether the first user perceives the second interpretation of the high pass-filtered second image within one or more refined hybrid images of the first plurality of refined hybrid images.

EEE9. The method of EEE 8, further comprising:
in response to the first user input indicating that the first user perceives the second interpretation of the high pass-filtered second image within the one or more refined hybrid images of the first plurality of refined hybrid images, displaying, on the display of the first playback device, a second plurality of refined hybrid images that are each smaller in size than each of the first plurality of refined hybrid images
receiving, with the one or more electronic processors, a second user input from the first user, the second user input indicating whether the first user perceives the second interpretation of the high pass-filtered second image within the one or more refined hybrid images of the second plurality of refined hybrid images;
determining, with the one or more electronic processors and based at least in part on the second user input, the optimized value of the media parameter;
in response to the first user input indicating that the first user does not perceive the second interpretation of the high pass-filtered second image within the one or more refined hybrid images of the first plurality of refined hybrid images, displaying, on the display of the first playback device, a third plurality of refined hybrid images that are each larger in size than each of the first plurality of refined hybrid images
receiving, with the one or more electronic processors, a third user input from the first user, the third user input indicating whether the first user perceives the second interpretation of the high pass-filtered second image within the one or more refined hybrid images of the third plurality of refined hybrid images; and
determining, with the one or more electronic processors and based at least in part on the third user input, the optimized value of the media parameter.

EEE10. The method of EEE 8 or EEE 9, wherein each refined hybrid image in the first plurality of refined hybrid images is displayed on the display simultaneously.

EEE11. The method of EEE 7, further comprising:
increasing, with the one or more electronic processors, the gain of the high pass-filtered second image within the refined hybrid image while the refined hybrid image is displayed on the display, wherein the gain of the high pass-filtered second image is increased until the first user input indicates that the first interpretation is no longer perceptible to the first user;
in response to receiving the first user input, ceasing increasing the gain of the high pass-filtered second image within the refined hybrid image and recording a first gain value (g−) corresponding to the gain of the high pass-filtered second image when the first user input was received that indicated that the first interpretation is no longer perceptible to the first user;
decreasing, with the one or more electronic processors, the gain of the high pass-filtered second image within the refined hybrid image while the refined hybrid image is displayed on the display, wherein the gain of the high pass-filtered second image is decreased until a second user input indicates that the second interpretation is no longer perceptible to the first user;
in response to receiving the second user input, ceasing decreasing the gain of the high pass-filtered second image within the refined hybrid image and recording a second gain value (g⁺) corresponding to the gain of the high pass-filtered second image when the second user input was received that indicated that the second interpretation is no longer perceptible to the first user;
determining, with the one or more electronic processors, a mid-point gain (g′) where a perception of the refined hybrid image by the first user changes from the first interpretation to the second interpretation; and
determining, with the one or more electronic processors, a magnitude value of an estimated quality of experience (QoE) transfer function that is personalized for the first user, wherein the magnitude value is associated with a first test frequency used to generate at least one of the low pass-filtered first image and the high pass-filtered second image.

EEE12. The method of EEE 11, wherein the first test frequency includes one of the first cutoff frequency and the second cutoff frequency.

EEE13. The method of EEE 11 or EEE 12, wherein increasing the gain of the high pass-filtered second image within the refined hybrid image while the refined hybrid image is displayed on the display is performed in response to a third user input that controls the gain of the high pass-filtered second image within the refined hybrid image while the refined hybrid image is displayed on the display; and
wherein decreasing the gain of the high pass-filtered second image within the refined hybrid image while the refined hybrid image is displayed on the display is performed in response to a fourth user input that controls the gain of the high pass-filtered second image within the refined hybrid image while the refined hybrid image is displayed on the display.

EEE14. The method of EEE 11 or EEE 12, wherein increasing the gain of the high pass-filtered second image within the refined hybrid image while the refined hybrid image is displayed on the display includes displaying a first plurality of refined hybrid images that each include different gain values of the high pass-filtered second image than each other;
wherein the first user input includes a first selection of a first refined hybrid image of the first plurality of refined hybrid images;
wherein decreasing the gain of the high pass-filtered second image within the refined hybrid image while the refined hybrid image is displayed on the display includes displaying a second plurality of refined hybrid images that each include different gain values of the high pass-filtered second image than each other; and
wherein the second user input includes a second selection of a second refined hybrid image of the second plurality of refined hybrid images.

EEE14.1. The method of any one of EEEs 1-14, wherein the media parameter is or comprises one or more of a media bit rate, a media frame rate, and a media resolution.

EEE14.2. The method of any one of EEEs 1-14.1, wherein the hybrid image comprises a first image, which is low-pass filtered by means of a low-pass filter having a predetermined low-frequency cut-off frequency, and a second image, which is high-pass filtered by means of a high-pass filter having a predetermined high-frequency cut-off frequency.

EEE14.3. The method of EEE 14.2, wherein the first interpretation corresponds to the first image being visible to a user and the second interpretation corresponds to the second image being visible to a user.

EEE 14.4. The method of EEE 14.2 or 14.3, wherein refining the image comprises adjusting one or more of the low-frequency cut-off frequency, the high-frequency cut-off frequency, the combination of the low-frequency cut-off frequency and the high-frequency cut-off frequency, a gain of the first image, a gain of the second image, a size of the first image, and a size of the second image.

EEE 14.5. The method of any one of EEE 1-14.4, wherein the optimized value of the media parameter is a third value of the media parameter.

EEE 14.6. The method of any one of EEE 1-14.5, wherein determining the optimized value of the parameter comprises determining, based at least in part on the first user input, a parameter indicative of vision capabilities of the first user viewing the hybrid image on the display, and determining the optimized parameter in response to the parameter indicative of the vision capabilities of the first user.

EEE15. A non-transitory computer-readable storage medium storing one or more programs configured to be executed by the one or more electronic processors of an electronic computing device including a network interface and the display, the one or more programs including instructions for performing the method of any of EEEs 1-14.

EEE16. An electronic computing device, comprising:
a network interface;
a display;
one or more electronic processors; and
   a memory storing one or more programs configured to be executed by the one or more electronic processors, the one or more programs including instructions for performing the method of any of EEEs 1-14.

Various features and advantages are set forth in the following claims.

1. A method comprising:
at least one of generating and selecting, with one or more electronic processors, a hybrid image associated with a first interpretation corresponding to a first value of a media parameter and a second interpretation corresponding to a second value of the media parameter, wherein the hybrid image includes a first visibility ratio between the first interpretation and the second interpretation;
refining, with the one or more electronic processors, the hybrid image to create a refined hybrid image that includes a second visibility ratio different than the first visibility ratio;
displaying, on a display of a first playback device, the refined hybrid image;
receiving, with the one or more electronic processors, a first user input from a first user, the first user input related to a first perception of the refined hybrid image by the first user;
determining, with the one or more electronic processors and based at least in part on the first user input, an optimized value of the media parameter; and
providing, over a network, first output media to the first playback device in accordance with the optimized value of the media parameter, the first output media configured to be output with the first playback device.

2. The method of claim 1, wherein the optimized value of the media parameter includes an approximate minimum resolution for approximate maximum quality of experience (minmax QoE resolution) that is personalized for the first user based at least in part on the first user input.

3. The method of claim 1, wherein the optimized value of the media parameter includes an estimated quality of experience (QoE) transfer function that is personalized for the first user based at least in part on the first user input.

4. The method of claim 1, wherein
refining the hybrid image to create the refined hybrid image includes scaling, by a first factor(S), a first cutoff frequency of a low pass filter used to filter a first image to a first scaled cutoff frequency, wherein the first cutoff frequency is selected based on the first value and the second value of the media parameter;
scaling, by the first factor, a second cutoff frequency of a high pass filter used to filter a second image to a second scaled cutoff frequency, wherein the second cutoff frequency is selected based on the first value and the second value of the media parameter;
filtering the first image with the low pass filter at the first scaled cutoff frequency to generate a low pass-filtered first image;
filtering the second image with the high pass filter at the second scaled cutoff frequency to generate a high pass-filtered second image;
combining the low pass-filtered first image and the high pass-filtered second image to generate a scaled cutoff frequency filtered hybrid image, wherein the low pass-filtered image provides the first interpretation, and wherein the high pass-filtered second image provides the second interpretation; and
scaling, by a second factor (S′), a size of the scaled cutoff frequency filtered hybrid image configured to be displayed on the display to a scaled size to generate the refined hybrid image.

5. The method of claim 4, wherein the first factor and the second factor are equivalent.

6. The method of claim 4, wherein the first cutoff frequency and the second cutoff frequency are equivalent.

7. The method of claim 4, wherein refining the hybrid image to create the refined hybrid image further includes at least one of adjusting a gain of the low pass-filtered first image to control the first interpretation of the low pass-filtered first image within the refined hybrid image; and
adjusting a gain of the high pass-filtered second image to control the second interpretation of the high pass-filtered second image within the refined hybrid image.

8. The method of claim 7, further comprising displaying, on the display of the first playback device, a first plurality of refined hybrid images that each include at least one of (i) different gain values of the high pass-filtered second image than each other and (ii) different sizes than each other;
wherein the first user input indicates whether the first user perceives the second interpretation of the high pass-filtered second image within one or more refined hybrid images of the first plurality of refined hybrid images.

9. The method of claim 8, further comprising:
in response to the first user input indicating that the first user perceives the second interpretation of the high pass-filtered second image within the one or more refined hybrid images of the first plurality of refined hybrid images, displaying, on the display of the first playback device, a second plurality of refined hybrid images that are each smaller in size than each of the first plurality of refined hybrid images;
receiving, with the one or more electronic processors, a second user input from the first user, the second user input indicating whether the first user perceives the second interpretation of the high pass-filtered second image within the one or more refined hybrid images of the second plurality of refined hybrid images;
determining, with the one or more electronic processors and based at least in part on the second user input, the optimized value of the media parameter;
in response to the first user input indicating that the first user does not perceive the second interpretation of the high pass-filtered second image within the one or more refined hybrid images of the first plurality of refined hybrid images, displaying, on the display of the first playback device, a third plurality of refined hybrid images that are each larger in size than each of the first plurality of refined hybrid images;
receiving, with the one or more electronic processors, a third user input from the first user, the third user input indicating whether the first user perceives the second interpretation of the high pass-filtered second image within the one or more refined hybrid images of the third plurality of refined hybrid images; and
determining, with the one or more electronic processors and based at least in part on the third user input, the optimized value of the media parameter.

10. The method of claim 7, further comprising:
increasing, with the one or more electronic processors, the gain of the high pass-filtered second image within the refined hybrid image while the refined hybrid image is displayed on the display, wherein the gain of the high pass-filtered second image is increased until the first user input indicates that the first interpretation is no longer perceptible to the first user;
in response to receiving the first user input, ceasing increasing the gain of the high pass-filtered second image within the refined hybrid image and recording a first gain value (g) corresponding to the gain of the high pass-filtered second image when the first user input was received that indicated that the first interpretation is no longer perceptible to the first user;
decreasing, with the one or more electronic processors, the gain of the high pass-filtered second image within the refined hybrid image while the refined hybrid image is displayed on the display, wherein the gain of the high pass-filtered second image is decreased until a second user input indicates that the second interpretation is no longer perceptible to the first user;
in response to receiving the second user input, ceasing decreasing the gain of the high pass-filtered second image within the refined hybrid image and recording a second gain value (g⁺) corresponding to the gain of the high pass-filtered second image when the second user input was received that indicated that the second interpretation is no longer perceptible to the first user;
determining, with the one or more electronic processors, a mid-point gain (g′) where a perception of the refined hybrid image by the first user changes from the first interpretation to the second interpretation; and
determining, with the one or more electronic processors, a magnitude value of an estimated quality of experience (QoE) transfer function that is personalized for the first user, wherein the magnitude value is associated with a first test frequency used to generate at least one of the low pass-filtered first image and the high pass-filtered second image.

11. The method of claim 10, wherein the first test frequency includes one of the first cutoff frequency and the second cutoff frequency.

12. The method of claim 10, wherein increasing the gain of the high pass-filtered second image within the refined hybrid image while the refined hybrid image is displayed on the display is performed in response to a third user input that controls the gain of the high pass-filtered second image within the refined hybrid image while the refined hybrid image is displayed on the display; and
wherein decreasing the gain of the high pass-filtered second image within the refined hybrid image while the refined hybrid image is displayed on the display is performed in response to a fourth user input that controls the gain of the high pass-filtered second image within the refined hybrid image while the refined hybrid image is displayed on the display.

13. The method of claim 10, wherein increasing the gain of the high pass-filtered second image within the refined hybrid image while the refined hybrid image is displayed on the display includes displaying a first plurality of refined hybrid images that each include different gain values of the high pass-filtered second image than each other;
wherein the first user input includes a first selection of a first refined hybrid image of the first plurality of refined hybrid images;
wherein decreasing the gain of the high pass-filtered second image within the refined hybrid image while the refined hybrid image is displayed on the display includes displaying a second plurality of refined hybrid images that each include different gain values of the high pass-filtered second image than each other; and
wherein the second user input includes a second selection of a second refined hybrid image of the second plurality of refined hybrid images.

14. A non-transitory computer-readable storage medium storing one or more programs configured to be executed by one or more electronic processors of an electronic computing device including a network interface and a display, the one or more programs including instructions for:
at least one of generating and selecting a hybrid image associated with a first interpretation corresponding to a first value of a media parameter and a second interpretation corresponding to a second value of the media parameter, wherein the hybrid image includes a first visibility ratio between the first interpretation and the second interpretation;
refining the hybrid image to create a refined hybrid image that includes a second visibility ratio different than the first visibility ratio;
displaying, on the display of a first playback device, the refined hybrid image;
receiving a first user input from a first user, the first user input related to a first perception of the refined hybrid image by the first user;
determining, based at least in part on the first user input, an optimized value of the media parameter; and
providing, over a network, first output media to the first playback device in accordance with the optimized value of the media parameter, the first output media configured to be output with the first playback device.

15. An electronic computing device, comprising:
a network interface;
a display;
one or more electronic processors; and
a memory storing one or more programs configured to be executed by the one or more electronic processors, the one or more programs including instructions for:
at least one of generating and selecting a hybrid image associated with a first interpretation corresponding to a first value of a media parameter and a second interpretation corresponding to a second value of the media parameter, wherein the hybrid image includes a first visibility ratio between the first interpretation and the second interpretation;
refining the hybrid image to create a refined hybrid image that includes a second visibility ratio different than the first visibility ratio;
displaying, on the display of a first playback device, the refined hybrid image;
receiving a first user input from a first user, the first user input related to a first perception of the refined hybrid image by the first user;
determining, based at least in part on the first user input, an optimized value of the media parameter; and
providing, over a network, first output media to the first playback device in accordance with the optimized value of the media parameter, the first output media configured to be output with the first playback device.
